(19) United States
(12) Patent Application Publication
(10) Pub. No.: US 2026/0195651 A1
(43) Pub. Date: Jul. 9, 2026

(54) RANDOM CONTRAST LEARNING-BASED LANGUAGE MODEL CONFIGURATION

(71) Applicant: Lumina AI, LLC, Tampa, FL (US)

(72) Inventors: Morten Middelfart, Tampa, FL (US); Benjamin A. Martin, Tampa, FL (US); Samuel Martin, Tampa, FL (US); Fadi G. Farhat, New York, NY (US)

(73) Assignee: Lumina AI, LLC, Tampa, FL (US)

(21) Appl. No.: 19/441,800

(22) Filed: Jan. 6, 2026

Related U.S. Application Data
(60) Provisional application No. 63/742,795, filed on Jan. 7, 2025.
(60) Provisional application No. 63/758,217, filed on Feb. 13, 2025.

(51) Int. Cl. G06N 20/00

(52) U.S. Cl. CPC G06N 20/00

(57) ABSTRACT

Described herein are techniques for using random contrast learning (RCL) to train models. Some embodiments can use RCL to obtain models of similar computing strength as deep-learning models, such as large language models, while using significantly fewer computational resources. This can result in a model with improved accuracy that is trained quicker and more efficiently than complex model architectures.

### CROSS-REFERENCE TO RELATED APPLICATIONS

This application claims the benefit of priority of U.S. Provisional Patent Application No. 63/742,795, filed Jan. 7, 2025, and U.S. Provisional Application No. 63/758,217, filed Feb. 13, 2025. The contents of these provisional applications are incorporated herein by reference in their entirety.

### BACKGROUND

Machine learning models learn patterns within training data to make predictions or decisions. Training these models involves iterative optimization, where the model adjusts its internal parameters based on data inputs, often requiring high-performance hardware like graphics processing units (GPUs) or specialized processors for large-scale computations. The complexity of these models can vary depending on a number of factors, such as the type of learning (e.g., supervised, unsupervised, reinforcement), the size of the dataset, and/or the depth of the model, which can impact memory usage, processing power, and training time.

### SUMMARY

The systems and methods described herein can configure language models to reduce computational demands for both training and inference operations. For example, systems and methods in accordance with the present disclosure can execute Random Contrast Learning (RCL) to efficiently configure models such that the models can be operated using any of various computing systems, including, for example and without limitation, non-specialized systems, such as Central Processing Units (CPUs), as well as parallel processing systems, such as Graphics Processing Units (GPUs). Systems and methods in accordance with the present disclosure can allow for improved development and implementation of RCL-based models. For example, deep-learning models often consume significant computational resources, necessitating the use of significant computing resources and/or specialized systems, such as Graphics Processing Units (GPUs), which can be computationally- and resource-intensive.

The application of RCL to the configuration of language models, including large language models (“LLMs”), can significantly reduce computational requirements, including power consumption and time, compared to traditional methods such as transformer neural networks (TNNs). In some implementations, RCL's pre-training efficiency allows scalable training on, for example, CPU-based systems, while maintaining or exceeding the accuracy and generalization of existing LLM architectures. Systems and methods in accordance with the present disclosure can address limitations of existing TNN-based pre-training techniques and across various hardware configurations, including CPUs and FPGAs.

RCL-based models for LLMs offer several technical advantages when compared to TNNs. For example, RCL-based models can perform as well or better than TNNs while improving training speeds. In some scenarios, the training speed increase can be orders of magnitude large. Additionally, as the complexity of the datasets increase, the training speed improvements can be maintained. TNNs, on the other hand, can experience significant performance drop off as complexity increases.

At least one aspect relates to an RCL-based model trained. For example, an RCL framework may be initialized on input text datasets. Contrastive sampling may be applied to define learning objectives. The model (e.g., the RCL-based model) may be trained using parameters determined from the contrastive sampling.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. As used in the specification and in the claims, the singular form of “a”, “an”, and “the” include plural referents unless the context clearly dictates otherwise.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1 is a block diagram of an example system for configuring models, in accordance with one or more embodiments.

FIG. 2 is a flowchart of an example process for configuring models, in accordance with one or more embodiments.

FIG. 3 is an illustrative diagram of an example system used to train machine learning models, in accordance with one or more embodiments.

FIGS. 4A-4E are charts of example results for different domains with which an RCL-based model can be trained, in accordance with one or more embodiments.

FIGS. 5-7 are plots of example results comparing different model frameworks to RCL-based frameworks, in accordance with one or more embodiments.

FIG. 8 is an illustrative diagram of a vocabulary and sample sequences of tokens, in accordance with one or more implementations.

FIG. 9 is an illustrative diagram of example training data used to perform an RCL-based training for a prediction model, in accordance with one or more implementations.

FIG. 10 is an illustrative diagram of an example training process for executing the RCL-based training, in accordance with one or more implementations.

FIG. 11 is an illustrative diagram of an example inference process for using a trained RCL-based prediction model to perform a predictive task, in accordance with one or more implementations.

FIG. 12 is an illustrative flowchart of an example process for training a prediction model, in accordance with one or more implementations.

FIGS. 13A-13E and FIGS. 14A-14E illustrates various performance charts comparing a prediction model trained using RCL-based techniques and using a model trained using non-RCL-based techniques, in accordance with one or more implementations.

FIG. 15 is an illustrative diagram of an example data pipeline, in accordance with one or more implementations.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Architecture

Unlike neural networks, which can have complex architectures with multiple layers (including multiple hidden layers) and numerous connections (e.g., fully connected layers), RCL may be configured using a simpler structure. For instance, in some embodiments each node may include a single parent node. This reduces the complexity and improves the speed of both training and inference. For example, fewer nodes and fewer connections corresponds to fewer weights, biases, and other settings that need to be tuned during training, significantly saving computing resources.

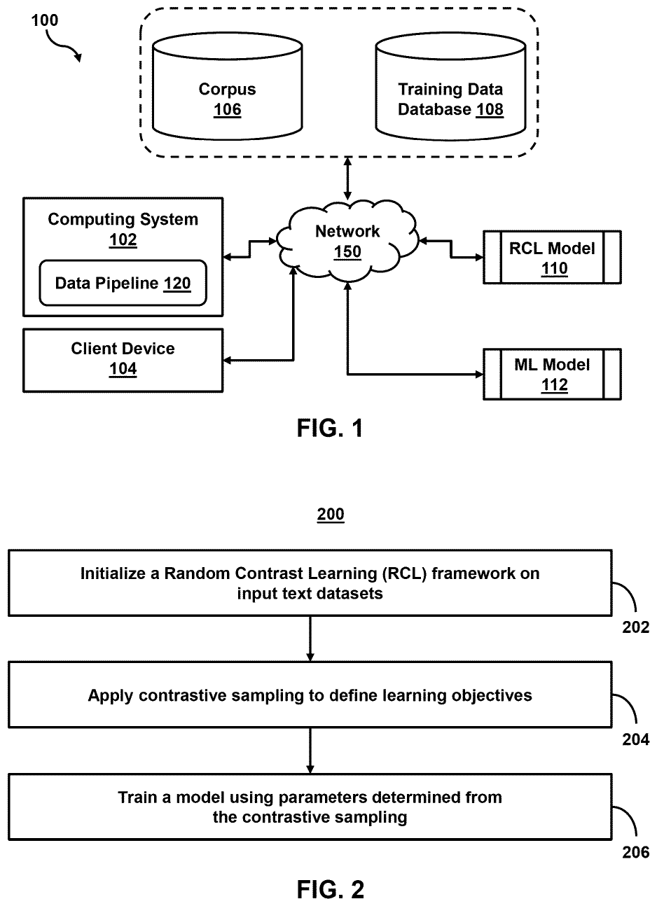

FIG. 1 is a block diagram of an example system 100 for configuring models, in accordance with one or more embodiments. In some embodiments, system 100 may be configured to train, fine-tune, update, or otherwise configure, one or more RCL-based models. In some cases, one or more non-RCL-based models may be configured using aspects of system 100.

System 100 may include a computing system 102. Computing system 102 may be configured to communicate with other components of system 100 via network 150 (e.g., the Internet, one or more Intranets, etc.). For example, Application Programming Interface (API) calls to one or more client devices, such as a client device 104, one or more databases, such as corpus 106 and/or training data database 108, one or more models, such as RCL model 110 and/or ML model 112, or other components of system 100, may transmitted across network 150. In some examples, computing system 102 may be configured to train a model using an RCL-training process to obtain RCL model 110. Computing system 102 may also be configured to deploy/host services for RCL model 110.

In some embodiments, computing system 102 may include one or more processors, memory, storage, input/output (I/O) interfaces, and network connectivity. The processors may include central processing units (CPU). In some cases, one or more GPUs may be included by computing system 102 in addition to one or more CPUs. Furthermore, in some examples, the RCL-based training process can be implemented on computing systems having GPU-based architectures. The processors of computing system 102 (e.g., the CPUs) can execute instructions and processes data. The memory of computing system 102 can store these instructions and data temporarily for quick access. Storage devices, such as hard drives or solid-state drives, can provide long-term data storage functionalities. I/O interfaces facilitate communication with peripheral devices like keyboards, mice, displays, or other components. Furthermore, computing system 102 may include communications systems for supporting network connectivity (e.g., connecting to network 150). The connections may be wired or wireless and can enable communications with other components of system 100 and/or devices external to system 100. Computing system 102 may be configured to perform various tasks, including data processing, storage, and communication, efficiently and reliably.

Client device 104 may refer to a computing device that accesses services and resources provided by a server (e.g., computing system 102) and/or a network (e.g., network 150). Client device 104 may include hardware components including processors (e.g., CPUs, GPUs, AI Accelerator chips, etc.), memory, storage, input/output interfaces, and communications systems. Client device 104 can correspond to a desktop computer, a laptop, a tablet, a smartphone, a mobile device, a wearable device, an IoT device, a headless device, or other device types, or combinations thereof. Client device 104 may execute client-side applications that interact with server-side applications to perform various tasks, such as browsing the internet, accessing email, and running software applications.

Corpus 106 may refer to one or more corpuses of data from which training data (stored in training data database 108) may be stored. The corpuses may include open source texts, crawled texts, knowledge-based texts, novels or other works of literature, image datasets (e.g., ImageNet), or other corpuses of data. Corpus 106 may include sources accessible via network 150. For example, Internet-based knowledge sources can be accessed by computing system 102, and corpus 106 may represent such types of resources.

Training data database 108 may store training data samples that can be used to train, validate, and/or test one or more models. The training data may be curated from corpus 106. For example, portions of data included in corpus 106 may be obtained, and one or more pre-processing steps may be performed to format the data for use during training. These processes may include, but are not limited to, space removal, sequence preparation, character conversion, and/or others. The training data samples can be stored in specific directories based on the classes of data represented.

RCL model 110 refers to a model or a set of models trained using the RCL process described herein. RCL model 110 is illustrated as a single model, however additional models may be included. ML model 112 refers to a model or set of models trained on one or more non-RCL-based processes. For example, ML model 112 may represent a large language model (LLM) trained using GPU-based computing stacks.

In some embodiments, RCL-based models, such as RCL model 110, may implement a shared-nothing architecture. In shared-nothing architectures, each process can operate independently without shared memory, further enhancing scalability. Share-nothing architectures generally include distributed computing models, where each node (or system) operates independently, with its own local memory, storage, and processing power. No direct sharing of data or memory between nodes may be used, meaning each node is responsible for its own subset of the data and processing tasks. The nodes can communicate, however, with communications occurring through network connections, and data being explicitly transferred from one node to another. Share-nothing architectures can be used with large-scale distributed systems, such as cloud computing platforms, databases (e.g., NoSQL), big data processing frameworks (e.g., Hadoop, Spark), and the like. In some embodiments, ML models, such as ML model 112, may implement share-based architectures.

In some embodiments, RCL model 110 (and/or ML model 112) may be deployed. For example, computing system 102 may deploy a classifier trained to classify inputs into one of a set of classes. For example, when an input is received by RCL model 110, RCL model 110 may classify the input into a particular class of outputs. In the scenario where the input includes a digital pathology image, RCL model 110 may classify the digital pathology image into a first class or a second class. Images classified into the first class may have been determined to include one or more features indicative of a diagnosis (e.g., certain cancers or other diseases). Images classified into the second class may have been determined to not include the features or were unable to detect the features with a high-enough degree of confidence.

### Technical Benefits of RCL

A. Scalability: In some embodiments, RCL scales linearly with dataset size and computational resources. As the dataset size increases, the training time and model size can increase at a predictable, linear rate. This can enable computing system 102 to allocate resources accordingly during training based on characteristics of the training data that will be used for training.

B. Efficiency: In some embodiments, RCL-based models (e.g., RCL model 110) train and run inference significantly faster than traditional neural network models. For example, RCL can train and run inference 10 times faster, 100 times faster, 1,000 times faster (e.g., 1,107 times faster training, 14 times faster inference) than a comparable deep learning model (e.g., ML model 112).

C. Resource Requirements: In some embodiments, RCL-based models (e.g., RCL model 110) can operate efficiently on CPUs. By leveraging CPUs, significant cost-savings can be attained. For example, CPU-based systems may be more accessible, reducing costs needed to access more expensive systems.

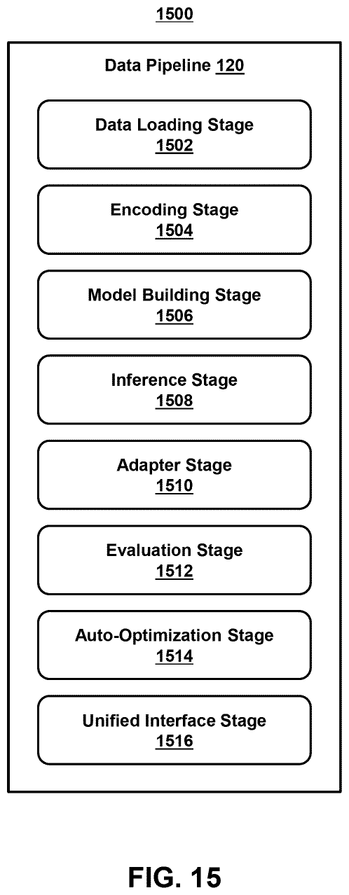

In some implementations, computing system 102 can include a data pipeline 120, which can integrate with one or more components of system 100 to transform data and build predictive models. Data pipeline 120 can process data from one form (e.g., a raw form) into another form, from which actionable insights or predictions can be derived. Deriving the data can be performed via data pipeline 120 through a series of stages. As an example, with reference to FIG. 15, a block diagram 1500 of data pipeline 120 is illustrated. Data pipeline 120 may include stages such as, for example, one or more of a data loading stage 1502, an encoding stage 1504, a model building stage 1506, an inference stage 1508, an adapter stage 1510, an evaluation stage 1512, an auto-optimization stage 1514, a unified interface stage 1516, or other stages. Data can be processed by some or all of the stages in data pipeline 120. Moreover, an order of the stages can vary.

Data loading stage 1502 may involve data being retrieved and processed from data sources such as, for example, corpus 106 or training data database 108. Corpus 106 may store raw data or corpuses of text, while training data database 108 may store processed sequences of tokens, which can be used for training one or more models (e.g., RCL model 110, ML model 112).

Encoding stage 1504 may involve encoding the retrieved data (e.g., retrieved from data loading stage 1502). In some embodiments, encoding stage 1504 can include computing system 102 transforming input data into encoded representations. For example, computing system 102 can include a tokenizer to tokenize input data into tokens.

Model building stage 1506 may involve using the encoded representations generated at the encoding stage to train a model (e.g., RCL model 110, ML model 112, etc.).

Inference stage 1508 may involve using the trained model (e.g., a trained RCL model, a trained ML model) to perform predictions. In some examples, inference stage 1508 can include client device 104 interacting with a model, such as RCL model 110 and/or ML model 112, to receive predictions based on input data provided by client device 104.

Adapter stage 1510 may involve a layer built on top of the initial model predictions made at inference stage 1508. For example, adapter stage 1510 can include computing system 102 leveraging telemetry data and refinement heads to improve model performance.

Evaluation stage 1512 can involve caching, logging, and evaluating data pipeline 120 and the stages of data pipeline 120 to ensure that data is being processed efficiently. Evaluation stage 1512 can ensure that metrics collected are integrated across all stages of data pipeline 120, reusing data and artifacts, maintaining detailed performance logs, and/or computing performance metrics that are indicative of model performance.

Auto-optimization stage 1514 can involve integrating training aspects for training RCL model 110 to tune hyperparameters of RCL model 110 dynamically. By dynamically tuning its hyperparameters, auto-optimization stage 1514 can ensure that RCL model 110 performs optimally over a given time period.

Unified interface stage 1516 may be configured to standardize interactions among various stages of data pipeline 120. For example, unified interface stage 1516 can ensure that workflows between stages, such as data loading stage 1502 and encoding stage 1504, remaining consistent regardless of data type.

FIG. 2 is a flowchart of an example process 200 for configuring models, in accordance with one or more embodiments. Process 200 may be implemented using computing system 102 of FIG. 1. In some examples one or more other components of system 100 may be used to perform some or all of the steps of process 200.

In some embodiments, process 200 may begin at step 202. For instance, at step 202, a random contrast learning (RCL) framework may be initialized on input text datasets. In some embodiments, initializing an RCL framework may include setting up a machine learning model that uses contrastive learning techniques to learn representations of data. This can include, for example, setting up an environment including configuration of necessary settings (e.g., logging, buffer allocation, initializing policies, etc.).

A framework, as described herein, refers to a structured set of components, rules, or guidelines that provide the foundational architecture computing system 102 to build, train, and/or deploy a model, such as RCL model 110 and/or ML model 112. The framework can be used by computing system 102 as instructions for how to process data, how to initialize a model, and how different stage of the model building and evaluating process interact. The framework can be adapted for different tasks. For example, an RCL framework, or Random Contrast Learning framework, refers to a specialized type of framework created to implement and manage the training of machine learning models using random contrast learning techniques. Computing system 102 can implement the RCL framework for initializing a training environment, including configuring settings (e.g., logging, buffer allocation, and policy initialization). Computing system 102 can apply contrastive sampling using the RCL framework to define learning objectives. The learning objectives can allow the model (e.g., RCL model 110) to learn distinctions between similar and dissimilar data samples. Computing system 102 can be instructed by the RCL framework to manage the preparation, encoding, and organization of training data. For example, the RCL framework can include instructions for tokenizing and creating encoded representations (e.g., embeddings). The RCL framework can orchestrate the training process by utilizing positive and negative sample pairs, dimensionality reduction, and optimization strategies including, amongst others, fractional sampling and greedy survivor halving.

At step 204, computing system 102 may be configured to apply contrastive sampling to define learning objectives. The contrastive sampling may be applied based on the RCL framework initialized on the input text datasets. Contrastive learning aims to learn representations by comparing similar and dissimilar pairs of data points. For example, in text classification, the process may involve comparing different text samples to determine how similar or dissimilar the samples are. As another example, in image processing, the process may involve comparing different views of the same image to learn invariant features.

Learning objects, for example, can refer to specific goals or outcomes to be achieved by the model (e.g., RCL model 110, ML model 112) during trained. During configuration and training of the model (e.g., RCL model 110, ML model 112), computing system 102 can use the learning objectives to learn how to distinguish between similar and dissimilar data samples, with the objective being to improve the model's classification abilities. Computing system 102 can define the learning objects by the task that the model is expected to perform (e.g., predicting the next token in a sequence, classifying an image, etc.). If the model refers to RCL model 110, computing system 102 can configure the learning objectives using contrastive samples. Contrastive sampling, for example, causes the model to learn to maximize similarity for related samples and minimize similarity for unrelated samples.

At step 206, computing system 102 may be configured to train a model using parameters determined from the contrastive sampling. Upon completion of the training (which may, for example, include after validation and testing), the model can be referred to as a trained model. In some implementations, the training may include performing iterative optimization, where the model adjusts its internal parameters based on data inputs. High-performance hardware like GPUs or specialized processors can be used for large-scale computations. RCL-based models, however, can also be implemented using CPUs and non-specialized processors.

In some embodiments, training the model may include obtaining a plurality of sequences of tokens from the input text datasets. For a sequence of tokens of the plurality of sequences of tokens, training the model may include generating a joined matrix. The joined matrix may include an encoded representation of each token of the sequence of tokens. From the plurality of sequences of tokes, a positive encoded representation and a negative encoded representation may be retrieved. The positive encoded representation may include a positive sequence of tokens and the negative encoded representation may include a negative sequence of tokens. The positive encoded representation, the negative encoded representation, and the joined matrix may be input into the model to obtain a positive similarity score and a negative similarity score. Based on the positive similarity score and the negative similarity score, a next token encoded representation may be determined. The joined matrix may be subsequently updated to increase the positive similarity score and decrease the negative similarity score. In some examples, an activation function may be selected to determine, based on the positive similarity score and the negative similarity score, the next token encoded representation. For example, the activation function may be a SoftMax function.

In some embodiments, the RCL framework may be configured to handle the specific requirements of the learning task. For example, the RCL framework may be configured to set up data pipelines, define loss functions (i.e., contrastive loss functions), configure training schedules, or other tasks, or combinations thereof.

In some embodiments, after initialization, the model may be evaluated on a validation set to assess its performance. Based on the results, the model may be fine-tuned to improve its accuracy and generalization. In some embodiments, at the outset of training, computing system 102 may be configured to segment the training data into training, testing, and validation datasets. The training datasets can be used to train the model, the testing to test the trained model, and the validation datasets to evaluate the performance of the trained (and tested) model.

In some embodiments, subsequent to the trained model being obtained, an input sample may be received via the trained model. An input sample may be received for input into the trained model. Using the trained model, a prediction may be generated based on the input sample. As an example, the input sample may include a text sequence and the prediction may include a determination of a next token in the text sequence. For example, the text sequence may include an n-token sequence and the prediction can refer to an n+1 token in the text sequence. The predicted next text token in the sequence can be provided (e.g., to an input device of the sequence of tokens) as a response. The text sequence can refer to a sequence of a predefined length. Training samples included by the input text datasets may have a length that is a same or similar length as the text sequence. For example, if a model has been trained on text sequences of length L, then the input data to the trained model may include a text sequence having a length that is less than or equal to L (or approximately L). As described herein, two or more sequences can be considered to have a same or similar length if the number of tokens included within the sequences is within a threshold number of tokens or percentage of tokens. For example, a first sequence including 100 tokens can be considered as having a similar length to a second sequence including 99 tokens, whereas a first sequence including 100 tokens may have a different length than a second sequence including 9 tokens. The threshold for what can be considered “similar” can also be varied. For instance, two sequences can be considered “similar” if the difference between the number of tokens included within each sequence is less than a threshold number of tokens or less than a threshold percentage of the token number of tokens included in either sequence. In some examples, the threshold number of tokens can be 0 tokens, 1 or more tokens, 5 or more tokens, 10 or more tokens, 100 or more tokens, or other quantities. In some examples, the threshold percentage can be +/−1%, +/−2%, +/−5%, +/−10%, or other quantities.

In some embodiments, where receiving input sample includes receiving a sequence of tokens, generating the prediction may include generating an encoded representation of each token in the sequence of tokens and determining, using the model, a subset of sequences of tokens that include the sequence of tokens. The subset of sequences of tokens may be selected from a plurality of sequences of tokens included in the input text datasets initialized using the RCL framework.

In some embodiments, determining the subset of sequences of tokens can include executing a join operation to join the encoded representation of each token of the sequence of tokens to form a joined matrix.

### Data Preparation

Data preparation may involve storing samples (e.g., text samples) in separate files using computing system 102. For example, these samples may be stored in training data database 108. Furthermore, some embodiments include computing system 102 organizing these samples, stored in separate files, into class-structured subfolders. The data preparation process may involve computing system 102 implementing minimal pre-processing. For example, for text data, the primary task for pre-processing may be for computing system 102 to clean the text data (i.e., removing spaces, formatting, converting punctuations, etc.).

Systems and methods in accordance with the present disclosure can configure machine learning models using techniques including random contrast learning (RCL). RCL enables machine learning models and/or classifiers to be more efficiently configured (for example and without limitation, trained, updated, fine-tuned, and have various machine learning operations performed). As a result of this improvement, machine learning models configured in accordance with the present disclosure can be deployed using CPU and/or FPGA hardware. This is in contrast to conventional neural network-based systems and other prediction models involving hidden layers, which often require large quantities of GPUs and/or other specialized processors to be configured.

The application of RCL to the configuration of language models, including large language models (“LLMs”), can significantly reduce computational requirements, including power consumption and time, compared to traditional methods such as transformer neural networks (TNNs). In some implementations, RCL's pre-training efficiency allows scalable training on CPU-based systems while maintaining or exceeding the accuracy and generalization of existing LLM architectures. Systems and methods in accordance with the present disclosure can address limitations of existing TNN-based pre-training techniques and across various hardware configurations, including CPUs and FPGAs.

For example, the training of large language models (LLMs) traditionally involves transformer neural networks, which are computationally intensive, requiring substantial hardware resources and energy. These methods have limitations, including high power consumption, long training times, and/or inefficient scaling with increasing dataset complexity or parameters. Further still, the process of obtaining and curating the data for training LLMs is not trivial, often requiring additional and extensive computing resources.

The technical solutions described herein address the aforementioned, as well as other, technical problems by implementing RCL-based models. Such RCL-based models allow for a universally applicable classification algorithm to be applied for efficient training without decreasing model accuracy. Furthermore, these RCL-based models can achieve superior accuracy in classification tasks while also maintaining exceptional computational efficiency, addressing one of the key technical problems faced by LLMs and other complex artificial intelligence architectures.

In some examples, a model's accuracy can be determined by determining a number/frequency of correct predictions. In some embodiments, where the model is trained to determine a next token after an initial set of tokens (i.e., predict a next token based on a preceding sequence of four tokens), the model's accuracy can be calculated as the frequency of correct predictions of the next token.

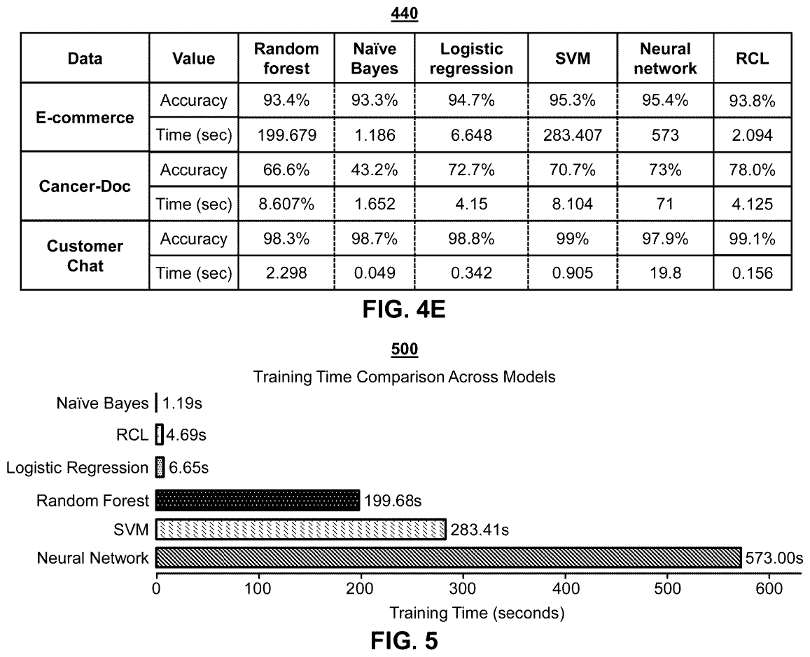

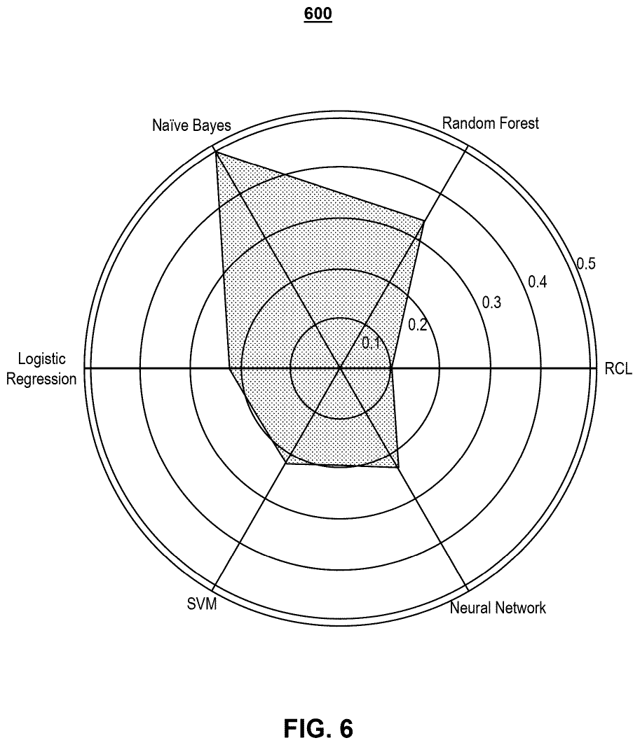

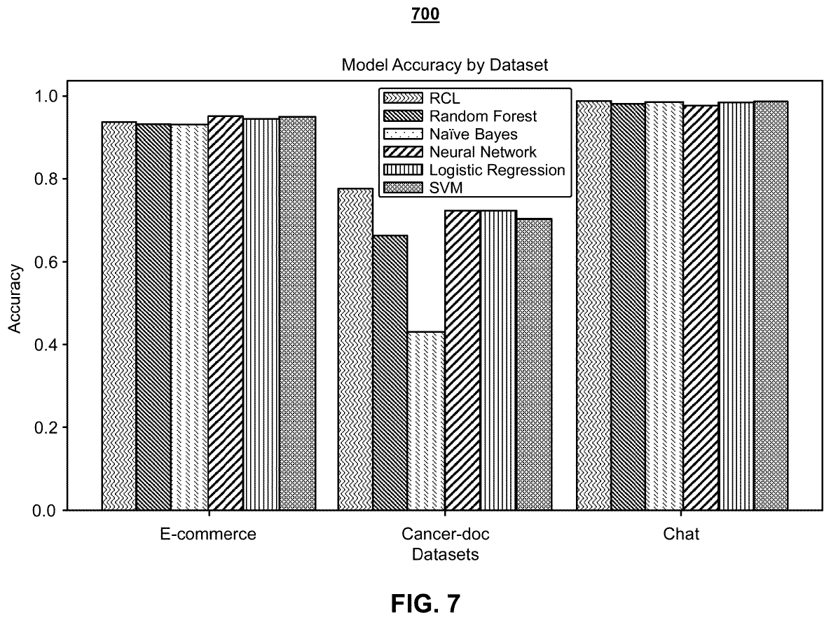

In some embodiments, RCL can provide efficient techniques for pretraining LLMs. For example, RCL may include using contrastive sampling to optimize classification tasks. Furthermore, RCL can achieve accuracies comparable to or exceeding transformer neural networks (TNNs) or other transformer-based models (e.g., encoder-decoder architectures). In some examples, when compared against TNNs, the RCL-based models can outperform by orders of magnitude in training (e.g., 2 or more orders of magnitude). RCL can also be optimized for training on CPUs and FPGA systems, without need for GPUs or specialized AI chipsets, as illustrated in FIGS. 5-7, for example. Still further, RCL-based models can outperform TNNs during inference operations (e.g., next-word prediction). In contrast to RCL-based models, TNNs can drop off significantly in accuracy as the document complexity increases.

In some implementations, computing system 102 can use techniques such as fractional sampling and greedy survivor halving integrated into auto-optimization processes (e.g., auto-optimization stage 1514). Using fractional sampling and greedy survivor halving, computing system 102 can efficiently tune hyperparameter by methodically evaluating parameter space to identify optimal model performance. Computer system 102 can manage the hyperparameter adjustments dynamically, which can allow computing system 102 to response to real-time data inputs to the model (e.g., RCL model 110, auto-optimization model 112).

Computing system 102 can use fractional sampling to evaluate hyperparameters across large datasets. For example, instead of running evaluations over an entire dataset, computing system 102 can leverage fractional sampling to select a representative fraction of input data, reducing the computational load while maintaining robustness in parameter assessment. As computing system 102 may process, during each iteration, a portion of the dataset, parameter configurations can be identified by computing system 102 without committing extensive resources upfront. This iterative refinement mirrors how human researchers can initially explore broad parameter landscapes before narrowing focus.

Computing system 102 can employ the greedy survivor halving alone or in combination with fractional sampling. The greedy survivor approach can include computing system 102 systematically pruning parameter configurations that perform poorly during each iteration, halving the search space, and directing computational resources toward more promising candidate parameters. By leveraging greedy survivor halving, computing system 102 can ensure that the best-performing configurations progress. Moreover, using fractional sampling and greedy survivor halving together can further accelerate the optimization process by focusing computing system 102's computational efforts on candidate parameters that have already demonstrated potential, thereby minimizing unnecessary computations on less effective configurations.

An aspect of the auto-optimization strategies includes integrating command-line interface (CLI) options. By setting CLI options, the initial parameters and constraints for fractional sampling and survivor halving can be input directly at runtime (e.g., using client device 104, computing system 102, or another device). CLI options can also enable tuning loop adjustments to be made in real-time, ensuring that computing system 102 selects the hyperparameters that align with specific project goals and resource limitations. For example, setting CLI options can adapt computing system 102 to handle use case scenarios ranging from rapid prototyping to extensive model refinement, providing a flexible, user-driven approach to model optimization.

As compared to typical TNNs, which can consume large quantities of computing resources (e.g., high memory requirements to store model parameters, use of GPUs/TPUs, parallel processing across multiple computing cores) as to require server or data center-based training and/or inference, systems and methods in accordance with the present disclosure can allow for more and/or all of the model pipeline to be deployed locally and/or using on-premises systems, (e.g., using local CPU systems). This can include performing training, fine-tuning, and/or inference using a same device that includes user interface features and that stores data to be processed. By leveraging CPU-based systems, latency can be reduced to allow for more secure operations by obviating the need to communicate data over network connections, to cloud systems, and/or to sub-processors (e.g., obviating the need for encryption data in transit). Moreover, the costs of some of the hardware components, such as (GPUs) and/or Tensor Processing Units (TPUs), can be 10-100 times that of Central Processing Units (CPUs), consuming substantially more resources to operate (e.g., in terms of energy to power the hardware, space to store the hardware, etc.). Described herein are technical solutions to these and other technical problems.

For example, results from a sample experiment comparing a model trained using RCL and a neural network (e.g., a PyTorch-based model) are provided below in the following tables.

Table 1 illustrates quantitative results from a sample experiment run on a Xeon processor. As seen by Table 1, the training time as complexity increases is significantly shorter for RCL training systems as compared to non-RCL training systems. Furthermore, accuracy maintains consistent high-level performance as complexity increases.

TABLE 1

| | Accuracy | | | Training Time (secs) | | | Inference Time (secs) | | |
|---|---|---|---|---|---|---|---|---|---|
| scale | PyTorch | RCL | delta | PyTorch | RCL | advantage | PyTorch | RCL | advantage |
| 10 | 98.13% | 98.12% | −0.01% | 432.00 | 3.76 | 115.0 | 30.41 | 4.56 | 6.7 |
| 20 | 98.07% | 98.05% | −0.02% | 1371.12 | 8.42 | 162.9 | 76.61 | 19.80 | 3.9 |
| 30 | 98.01% | 98.03% | 0.02% | 3198.85 | 14.45 | 221.3 | 156.33 | 49.80 | 3.1 |
| 40 | 97.97% | 98.01% | 0.04% | 5500.88 | 22.04 | 249.6 | 271.15 | 100.39 | 2.7 |
| 50 | 97.95% | 98.01% | 0.06% | 8250.99 | 30.43 | 271.1 | 399.97 | 174.07 | 2.3 |
| 60 | 97.96% | 98.01% | 0.05% | 12431.09 | 40.60 | 306.2 | 556.50 | 275.22 | 2.0 |
| 70 | 97.95% | 98.01% | 0.06% | 16972.78 | 50.59 | 335.5 | 746.77 | 411.65 | 1.8 |
| 80 | 97.77% | 98.01% | 0.24% | 21458.85 | 61.91 | 346.6 | 941.30 | 586.55 | 1.6 |
| 90 | 97.28% | 98.01% | 0.73% | 27529.68 | 74.80 | 368.1 | 1197.25 | 788.52 | 1.5 |
| 100 | 96.53% | 98.01% | 1.48% | 33517.07 | 89.07 | 376.3 | 1452.78 | 1068.63 | 1.4 |

Table 2 illustrates qualitative results from a sample experiment run on a Xeon processor. As seen by Table 2, for various training materials (i.e., open source texts, such as “The Verdict,” “Romeo and Juliet,” “A Christmas Carol,” “Doctrina Christiana,” “Pride and Prejudice,” “Little Women,” “The Count of Monte Cristo,” and “Les Miserables”), RCL-based models show improved performance over the non-RCL models as complexity increased.

TABLE 2

| | | | Training | | Inference | |
|---|---|---|---|---|---|---|
| | Accuracy | | Time (secs) | | Time (secs) | |
| document | PyTorch | RCL | PyTorch | RCL | PyTorch | RCL |
| 1. The- | 98.19% | 98.13% | 19.52 | 0.34 | 2.47 | 0.91 |
| Verdict | | | | | | |
| 2. Romeo- | 96.09% | 94.67% | 229.17 | 3.08 | 20.92 | 6.40 |
| And- | | | | | | |
| Juliet | | | | | | |
| 3. A- | 95.88% | 95.10% | 248.75 | 3.19 | 22.31 | 6.33 |
| Christmas- | | | | | | |
| Carol | | | | | | |
| 4. Doctrina- | 94.73% | 93.83% | 260.93 | 3.05 | 22.60 | 6.42 |
| Christiana | | | | | | |
| 5. Pride- | 86.23% | 90.45% | 1,193.70 | 14.69 | 93.73 | 19.10 |
| And- | | | | | | |
| Prejudice | | | | | | |
| 6. Little- | 77.65% | 86.70% | 2,491.10 | 30.35 | 161.93 | 61.93 |
| Women | | | | | | |
| 7. The- | 57.73% | 81.10% | 7,700.61 | 118.43 | 425.11 | 296.87 |
| Count- | | | | | | |
| Of-Monte- | | | | | | |
| Cristo | | | | | | |
| 8. Les- | 57.93% | 84.07% | 12,159.87 | 156.10 | 610.08 | 652.06 |
| Miserables | | | | | | |

RCL represents a significant advancement in machine learning, particularly for text classification tasks. Its ability to scale linearly with dataset size and compute, combined with its efficiency and minimal resource requirements, makes it a powerful alternative to traditional neural network models. RCL's unique approach to handling data and its robust performance across different datasets highlight its potential for widespread application in various fields. With respect to entropy handling, RCL's performance is less affected by changes in entropy compared to neural networks. This makes it more robust and dependable for various types of data. RCL can provide for sublinear Inference scaling: As model size increases, RCL's inference time scales sub-linearly, promising even greater performance improvements at larger scales.

For example, RCL can achieve high performance (e.g., accuracy) without requiring extensive training data or powerful computing hardware. Instead, RCL can be designed to work efficiently with limited resources, such as CPU-based systems, and the like. RCL can focus on perception and experience as a framework for how data is processed. This approach can allow RCL to identify unique and interesting patterns in sequential data (e.g., text data, time-series data, etc.). RCL can operate with minimal preprocessing by simplifying the data preparation process, providing additional technical benefits by conserving/reducing time and computational resources.

### Contrast Technique

In some embodiments, computing system 102 may execute the RCL process, which may include comparing samples (i.e., text samples) with random arrays (i.e., text arrays). The random array may be used instead of using similar/dissimilar samples (i.e., similar or dissimilar text). By using random arrays for sample comparison, non-unique patterns can be filtered out while distinctive patterns can be highlighted. The process of filtering out non-unique patterns while boosting distinctive patterns can improve the model's ability to classify samples, such as text samples, image samples, video samples, or other samples, accurately.

### Technical Benefits

As compared to non-contrastive learning techniques, the technical solutions described implementing RCL-based models (e.g., RCL model 110) can achieve faster training processes with high accuracy. Furthermore, computational resources (e.g., hardware, software), power (e.g., electricity to operate the computational resources, amount of computational resources used), and costs associated with the computational resources and power, can be reduced. Furthermore, while the technical solutions allow for efficient and accurate training for large amounts of data, the RCL framework can also be flexible enough to handle other classification tasks efficiently (e.g., small text classification tasks), even with small training data amounts.

Additional technical benefits of the RCL-based models and training process include how well these handle data. For example, the data used is not heavily influenced by transformations and/or leakage, making it dependable for real-world applications. Still further, RCL-based models are adaptable for different domains. For example, RCL-based models can be used for autonomous driving applications, medical image and digital pathology applications, and others.

Yet another technical benefit described herein relates to the speed with which RCL can train a model. A particular benefit of RCL is the predictability and scalability of the training. For example, RCL's training speed can scale as a function of dataset size and compute power. This predictable nature makes the resource allocation for training quick, simple, and scalable as needed, which can further reduce costs, save time, and improve efficiency. As an illustrative example, RCL training scales linearly, meaning that doubling the dataset size will approximately double the training time.

Still further, additional technical benefits can be found at runtime. For example, the inference speed (e.g., how quickly the model outputs a prediction, or performs an action, based on an input) can remain substantially constant at scale. This improvement in resolution time, while maintaining or improving accuracy, provides significant benefits over neural network models where inference time can increase exponentially with the number of nodes and number of layers.

As mentioned above, the adapter stage of data pipeline 120 (e.g., adapter stage 1510) can be used to enhance a model's ability to process and refine complex data. For example, adapter stage 1510 can enable data pipeline 120 to bridge various data types (e.g., text, tabular, image data, etc.) into a unified workflow, enabling complex input data to be processed effectively. Computing system 102 can derive contextual information from diverse datasets (e.g., datasets including data of a variety of different data types) during training and can apply the refined understanding to improve model performance.

Adapter stage 1510 can integrate features extracted from data of different data types into a unified set of representations. For example, the integration can be accomplished by processing each feature through specialized extraction configured to extract different types of features from different types of data, convert those features into compatible encoded formats, and merging these encoded representations using operations such as concatenation, averaging, or multidimensional joining. Adapter stage 1510 can use the resulting unified set of representations to analyze and utilize information from diverse data sources within a single workflow, supporting downstream tasks like prediction, classification, or further refinement. During training, adapter stage 1510 can leverage telemetry and residual learning to monitor and collect contextually relevant information. The contextually relevant information can be used by computing system 102 to ensure that the model (e.g., RCL model 110, ML model 112) can recognize as well as understand the nuances of the input data's features that might be detected. For example, computing system 102 can integrate various data types: two or more of text, numerical, and imaging (e.g., pixel-based) data, for example, extracting features from that data and generating a unified description of those features. The extracted data can include intents of the text data, transformations used for the numerical data, and objects detected within the image data.

Computing system 102 can detect which data types are included within the input data includes and transform those data types into a single data type. For example, computing system 102 can analyze the input data's characteristics and applying specialized extraction techniques tailored to different data types. At adapter stage 1510, feature extraction can be performed to extract distinctive features associated with each data type detected (e.g., text data, numerical data, image data). For example, text data can be analyzed at adapter stage 1510 for semantic meaning or intents, numerical data can undergo transformations at adapter stage 1510 to expose trends, and image data can be analyzed at adapter stage 1510 to detect objects through pixel analysis. In an example, if the input sample include multiple data types, adapter stage 1510 can identify the multiple data types within the input sample. The input sample can be transformed such that instead of including the multiple data types, the input sample (or transformed version of the input sample) can include a single data type. The single data type can be one of the multiple data types. For example, if the input sample includes data of a first data type and a second data type, the transformed sample can include data of the first data type or the second data type. The single data type can be different from the multiple data types. For example, if the input sample includes data of a first data type and a second data type, the transformed sample can include data of a third data type different from the first and second data types.

Auto-optimization stage 1514 can also be integrated with adapter stage 1510 to enable dynamic adjustments to be made to a refinement head. A refinement head refers to an additional layer or component in a model, such as RCL model 110 or ML model 112, designed to enhance or fine-tune predictions. The refinement head can act as a secondary tuning mechanism for the output data, enabling more precise outcomes particularly where complex and nuanced decision-making may be required. Integrating auto-optimization as a stage in data pipeline 120 can allow adapter stage 1510 to dynamically adjust its parameters based on continuous performance feedback, enabling data pipeline 120 to adapt to changing data patterns and operational conditions. This constant fine-tuning process ensures that adapter stage 1510 remains efficient and effective across different use cases.

### Training Example

The foregoing example is an illustration of one embodiment of training a model using RCL-based techniques, as described herein. Additional or fewer steps may be performed, and some steps may be performed at different times, or in different orders.

In some embodiments, a model to be trained may include a model trained to predict a “next” word in a sequence. For example, given a sequence of N tokens, the model may be trained to predict what the N+1 token will be.

To train the model using the RCL technique, a training corpus may be selected, retrieved, accessed, etc., from which training data can be formed. For a text-based RCL model, the corpus may include text data representing an example text. The example text may be open-source text libraries, such as scikit-learn, spaCy, NLTK, Transformers (by Hugging Face), Gensim, TextBlob, FastText, AllenNLP, OpenNLP, or PyTorch-NLP. The example text may, additionally or alternatively, include open source books, such as selections from Project Gutenberg Texts, The English Wikipedia, TheBooksCorpus, and/or others.

For non-text-based models, the training samples may be retrieved from other open-sourced libraries. For example, the ImageNet dataset, the CIFAR-10/100 dataset, or others, can be used for image classification, the COCO dataset can be used for object detection and segmentation, the MNIST dataset can be used for handwritten digit recognition, the LIBRISPEECH dataset can be used for speech recognition, the SQUAD dataset can be used for question answering, etc. As an illustrative example, the corpus may include the following text:

You will rejoice to hear that no disaster has accompanied the commencement of an enterprise which you have regarded with such evil forebodings.

This text includes a sequence of 24 words (i.e., “You”, “will”, “rejoice”, “to”, “hear”, “that”, “no”, “disaster”, “has”, “accompanied”, “the”, “commencement”, “of”, “an”, “enterprise”, “which”, “you”, “have”, “regarded”, “with”, “such”, “evil”, “forebodings”) and 1 punctuation (“.”). Of the 24 words, one word—“you”—is included twice.

Therefore, based on this sample text corpus, there are 24 tokens: {“You”, “will”, “rejoice”, “to”, “hear”, “that”, “no”, “disaster”, “has”, “accompanied”, “the”, “commencement”, “of”, “an”, “enterprise”, “which”, “you”, “have”, “regarded”, “with”, “such”, “evil”, “forebodings”, “.”}.

For a model being trained to predict a next token for a given sequence of tokens, some embodiments may include selecting a sequence length for the training samples. As an example, a five-token sequence may be used, where the fifth token is the target token being predicted, and the first four tokens are used as input. This can produce the sequences, such as the following:
1. “You”, “will”, “rejoice”, “to”, “hear”
2. “will”, “rejoice”, “to”, “hear”, “that”
3. “rejoice”, “to”, “hear”, “that”, “no”
4. “to”, “hear”, “that”, “no”, “disaster”
5. “hear”, “that”, “no”, “disaster”, “has”
6. “that”, “no”, “disaster”, “has”, “accompanied”
7. “no”, “disaster”, “has”, “accompanied”, “the”
8. “disaster”, “has”, “accompanied”, “the”, “commencement”
9. “has”, “accompanied”, “the”, “commencement”, “of”
10. “accompanied”, “the”, “commencement”, “of”, “an”
11. “the”, “commencement”, “of”, “an”, “enterprise”
12. “commencement”, “of”, “an”, “enterprise”, “which”
13. “of”, “an”, “enterprise”, “which”, “you”
14. “an”, “enterprise”, “which”, “you”, “have”
15. “enterprise”, “which”, “you”, “have”, “regarded”
16. “which”, “you”, “have”, “regarded”, “with”
17. “you”, “have”, “regarded”, “with”, “such”
18. “have”, “regarded”, “with”, “such”, “evil”
19. “regarded”, “with”, “such”, “evil”, “forebodings”
20. “with”, “such”, “evil”, “forebodings”, “.”

Additional sequences may be created using the remaining text, if any, included in the corpus.

Each token can be mapped to a numerical representation of that token. Some example techniques that can be used to generate the encodings include, but are not limited to, one-hot encodings, word embeddings (e.g., using Word2Vec, GloVe), using a Term Frequency-Inverse Document Frequency (TF-IDF), or others (e.g., LSA, LDA, PCA). For simplicity, the numerical representations of the tokens for the representative text above may be abstracted using E1-E24, where E1 represents the token “you,” E2 represents the token “will,” and so on.

Thus, the sequences above can be represented using the encodings above, as illustrated in the following example:
1. E1, E2, E3, E4, E5
2. E2, E3, E4, E5, E6
3. E3, E4, E5, E6, E7
4. E4, E5, E6, E7, E8
5. E5, E6, E7, E8, E9
6. E6, E7, E8, E9, E10
7. E7, E8, E9, E10, E11
8. E8, E9, E10, E11, E12
9. E9, E10, E11, E12, E13
10. E10, E11, E12, E13, E14
11. E11, E12, E13, E14, E15
12. E12, E13, E14, E15, E16
13. E13, E14, E15, E16, E17
14. E14, E15, E16, E17, E18
15. E15, E16, E17, E18, E19
16. E16, E17, E18, E19, E20
17. E17, E18, E19, E20, E21
18. E18, E19, E20, E21, E22
19. E19, E20, E21, E22, E23
20. E20, E21, E22, E23, E24

The same or similar steps can be performed for some or all of the other text included in the sample corpus used. Using the encoding instead of the text tokens, in the aforementioned example, can reduce computation times and resources requirements by providing reduced-data representations of the training data. In some embodiments, the sequences can be arranged in groups based on the target token being predicted. For example, all sequences ending in a particular token (e.g., ending with the token “you” or E1) may be grouped together and written to a separate file stored in a separate directory for that target token.

In some embodiments, pairs of tokens may be selected for training.

For each token pair, a model can be trained to predict a likely next token given an input token or set of tokens. For example, the model can be provided with the first sequence: E1, E2, E3, E4. The model can predict a next encoded representation of the token. If the model predicts the next encoded representation is E5, corresponding to the text token “hear,” then that means the model correctly predicted the next token. However, if the model predicts the next encoded representation to be E19, corresponding to the text token “regarded,” then this may indicate the model did not correctly predict the next token. Model parameters can be adjusted based on whether the predicted token (or encoded representation of that token) is correct.

In some embodiments, an optimization process can be used to optimize the model parameter values. For example, for contrastive learning, some example optimization processes that can be used include, but are not limited to, Bootstrap Your Own Latent (BYOL), SimSiam, and Simple Contrastive Learning of Representations (SimCLR).

As an example, the contrastive learning process may include emphasizing the model to identify similar samples while distancing the model's recognition of dissimilar samples.

In some embodiments, the contrastive learning process may include emphasizing similar training samples (sequences and/or text tokens) while maximizing the separation of dissimilar training samples.

At runtime, the model can be provided with a word, token, set of tokens, etc., which can be used to predict the next token. For example, a sequence of four words can be input to the model and, based on its training, the model can predict the fifth word in the sequence.

It should be noted that the example above relates to text classification, however the RCL process described herein can train models for other domains, such as image classifications. For example, instead of training one text sample, image samples can be used to train the model to predict classifications for those images. As an example, the images may be predicted to be in a first class or a second class, where the first class indicates that a particular object or set of objects was recognized within the image, while the second class may indicate that a particular object or set of objects was not recognized within the image. In some embodiments, to train such a model, one or more feature extraction processes may be performed to encode the images for input. For example, Scale-Invariant Feature Transform (SIFT), Histogram of Oriented Gradients (HOG), Speeded-Up Robust Features (SURF), or other processes, can be used to generate the encoded representations of the images for created the training samples. For each pixel in the image, the model can learn a predicted “next” pixel (e.g., adjacent pixel). For example, based on an image gradient in the image, a next pixel can be predicted based on a directionality of other similar pixels in the image (or in other images).

In some implementations, computing system 102 may be configured to train a prediction model, such as RCL model 110. Computing system 102 may generate a vocabulary that can be used to train a model, such as a random contrast learning (RCL) model. In some implementations, the vocabulary may include a set of tokens (e.g., including “Token 1” thru “Token N”). The value N can be any integer value (e.g., 10 or more, 100 or more, 1,000 or more, 100,000 or more, and the like). The number of tokens (e.g., “N”) can depend on the text used for training data generation. For example, corpus 106 may be configured to store text used to generate training data. The training data, which can be used to train one or more prediction models, may then be stored using training data database 108.

In some implementations, the text used for training data generation may be derived from different sources. For example, text may be scraped from webpages or other online sources. In some examples, the text may be derived from other media formats, such as video and/or audio. In still further examples, the text may be obtained from textbooks, dictionaries, encyclopedias, and/or works of literature (e.g., “The-Verdict,” “Romeo-And-Juliet,” “A-Christmas-Carol,” “Doctrina-Christiana,” “Pride-And-Prejudice,” “Little-Women,” “The-Count-Of-Monte-Cristo,” “Les-Misérables”). A user, such as a user operating client device 104, may submit training requests indicating which text is to be used for training data generation. Client device 104 may submit the training requests to computing system 102 across network 150. Upon receipt of the training request, computing system 102 may determine the text to retrieve from corpus 106, as well as any other information needed (e.g., authorization to use the text, configuration files, libraries, data processing rules, etc.).

In some implementations, computing system 102 may be configured to perform a tokenization process to the selected text. The tokenization schema used may be varied depending on the type of text being analyzed. In some implementations, longer texts may be tokenized by breaking a sentence into smaller units based on predefined rules, whereas shorter texts may be tokenized using a subword tokenizer, (e.g., Byte Pair Encoding (BPE)) and/or a character-level tokenizer. Alternative tokenization schemas are also possible and the aforementioned are described as examples merely for brevity.

Tokenization refers to a process whereby text can be converted into tokens. Tokenization breaks the text into smaller units, such as words, subwords, characters, or other units of text. For instance, word tokenization may split text into individual words. As an example, the sentence “I love machine learning” can be tokenized as {“I,” “love,” “machine,” “learning”}. Some models may use subword tokenization, which breaks words into smaller units to handle rare or complex words. For instance, using Byte Pair Encoding (BPE), the word “unhappiness” may be split into the subwords {“un”, “happiness”}. Another approach may include character tokenization, which treats each character as a separate token. For example, the word “cat” may be represented as {“c,” “a,” “t”}. Tokenization can also handle whitespace and punctuation. For example, tokenizers can remove punctuation, while others preserve punctuation (e.g., the phrase “Hello, world!” may be tokenized as {“Hello”, “,”, “world”, “!”}. After being tokenized, the tokens may be mapped to numerical token IDs using a vocabulary, allowing a machine learning model to process the text for learning or prediction.

In some implementations, computing system 102 may convert the selected text into text tokens. Computing system 102 may be configured to segment the text tokens into sequences of tokens of a particular sequence length. For example, a selection (e.g., default, user-selected) of a context window for data samples may be chosen, where the selection indicates a sequence length. The sequence length can specify a number of tokens to be included in a sequence. In some examples, the sequence length may depend on the use case. For example, for next word prediction tasks, sequence lengths of 4 or more tokens, 5 or more tokens, 10 or more tokens, etc., may be used. In examples referring to next word prediction (which is referred to also as “next token prediction” because a next token is predicted and then mapped to a corresponding word to determine the next word), the sequence length may include the reference token or may not include the reference token. For example, a sequence length of 4 tokens may indicate that the next word being predicted is the 5th word, and the stored sequence may include the 5th word/5th token. Alternatively, a sequence length of 4 tokens may include the reference token. For example, in this scenario, the 4th token may represent the reference token, and the first three tokens may be used as context to predict the 4th token.

In some implementations, computing system 102 may be configured to select a text from a plurality of available texts stored in corpus 106 from which to create the vocabulary. As an illustrative example, a selection of Romeo and Juliet by William Shakespeare as the referenced text may be made. Computing system 102 may retrieve the reference text and perform a tokenization process. For simplicity, a word tokenization process is described, however other tokenization processes may be used. In the illustrative example, the first two lines of Romeo and Juliet are:

“Two households, both alike in dignity,

In fair Verona, where we lay our scene.”

Using this example, computing system 102 may be configured to split the text into separate words. This segmentation process may include separating punctuations or other characters. Continuing the previous example, the segmented version of the first two lines are:
[“Two”, “households”, “,”, “both”, “alike”, “in”, “dignity”, “,”,
“In”, “fair”, “Verona”, “,”, “where”, “we”, “lay”, “our”, “scene”, “,”]

Now segmented, each word can be represented as a token by including a token ID to represent the word. For example, “Two” may be mapped to “Token 1”; “households” may be mapped to “Token 2”; “,” may be mapped to “Token 3”; “both” may be mapped to “Token 4”; “alike” may be mapped to “Token 5”; and so on. Thus, the first two lines of the text of Romeo and Juliet can, in the example tokenization, be represented as the sequence of tokens {“Token 1”, “Token 2”, “Token 3”, “Token 4”, “Token 5”, “Token 6”, “Token 7”, “Token 3”, “Token 8”, “Token 9”, “Token 10”, “Token 3”, “Token 11”, “Token 12”, “Token 13”, “Token 14”, “Token 15”}.

Tokens can appear multiple times within the text. For example, Token 3 may represent the punction “,”, and therefore may appear in multiple locations. Therefore, although the example sentence from the text includes 15 unique tokens, some of those tokens appear more frequently than others as their corresponding words occur more frequently.

In some implementations, the token identifiers may be transformed based on term frequency across the reference text and across other reference texts. For example, Term Frequency-Inverse Document Frequency (TF-IDF), which refers to a numerical measure evaluating an importance of a word within a document relative to a larger collection of documents (the corpus). TF-IDF combines Term Frequency (TF), which counts how often a word appears in a document, with Inverse Document Frequency (IDF), which down-weights words that appear frequently across many documents. TF-IDF is also beneficial due to its computational efficiency, which reduces the impact of common words, allowing models to focus on a smaller, more relevant subset of terms, thereby improving indexing, search speed, and memory usage in large text datasets. TF-IDF highlights important, context-specific words while reducing the influence of common words like (e.g., “the”, “is”, etc.).

Tokenized, computing system 102 may form sequences. These sequences may be used to generate training data for prediction model training. In some implementations, the prediction model training may include next word prediction tasks. Next word prediction refers to a process in which a model predicts the most likely word to follow a given sequence of words. The model analyzes the context of the input text by using learned representations of words and their relationships. It assigns probabilities to potential next words based on patterns found in training data. For example, given the input sequence, “The cat sat on the”, the model may predict the next word as being “mat”, “cushion”, or “floor”, with varying probabilities. The word associated with the greatest probability may be the selected word.

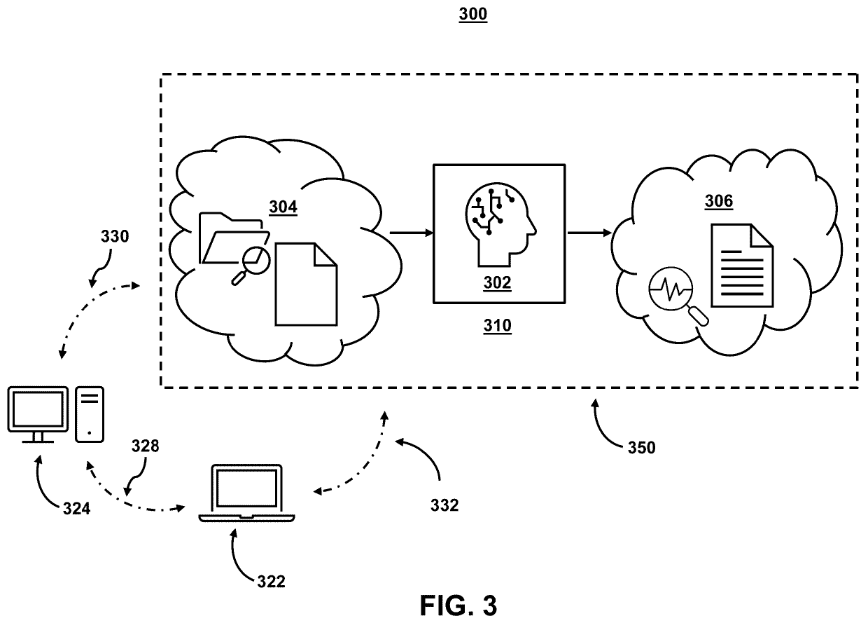

FIG. 3 is an illustrative diagram of an example system 300 used to train machine learning models, in accordance with one or more embodiments. For example, FIG. 3 may show illustrative components for implementing RCL based training as well as non-RCL based training to obtain RCL-based models (e.g., RCL model 110) and non-RCL-based models (ML model 112).

Furthermore, system 300 can implement these techniques (e.g., RCL-training) using reduced computational resources (e.g., hardware, software), power (e.g., electricity to operate the computational resources, amount of computational resources used), and costs associated with the computational resources and power. Furthermore, while the technical solutions allow for efficient and accurate training for large amounts of data, the RCL framework can also be flexible enough to handle other classification tasks efficiently (e.g., small text classification tasks), even with small training data amounts.

As shown in FIG. 3, system 300 may include mobile device 322 and user terminal 324. Computing system 102 and/or client device 104 of FIG. 1 may be implemented using one or more of mobile device 322 and/or user terminal 324, as well as other devices, systems, services, etc. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices.

FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data.

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to a desired task or set of tasks.

Each of these devices may also include electronic storage. The electronic storage may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include one or more components of computing system 102 of FIG. 1. Cloud components 310 may access one or more databases (e.g., corpus 106, training data database 108). In some examples, cloud components 310 may access a cloud-based memory. The cloud-based memory may store a model, such as RCL model 110, ML model 112, or other models.

Cloud components 310 may include model 302, which may be a machine learning model, artificial intelligence model, etc. (which may be referred collectively as “models” herein). In some examples, model 302 may represent an instance of RCL model 110. In some examples, model 302 may represent an instance of ML model 112. The process of training described may be used for training of model 302 for both RCL model 110 and ML model 112. In some embodiments, separate cloud components 310 may be used to train model 302 if model 302 corresponds to RCL model 110 (or a model like RCL model 110), while other cloud components 310 may be used to train model 302 if model 302 corresponds to ML model 112 (or a model like ML model 112).

Model 302 may take inputs 304 and provide outputs 306. The inputs may include multiple data sets, such as a training data set and a test data set. Each of the plurality of data sets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., training sample results and/or evaluation sample results).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information).

In some embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network (i.e., ML model 112). In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output. Some or all of these steps may be performed, for example, during training of model 302 corresponding to an RCL model (e.g., RCL model 110).

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., evaluation metric scores and/or model performance scores). However, RCL-based models, such as RCL model 110, may not necessitate multi-layer model architectures, and can instead operate on a single node, or single-parent node-like design.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

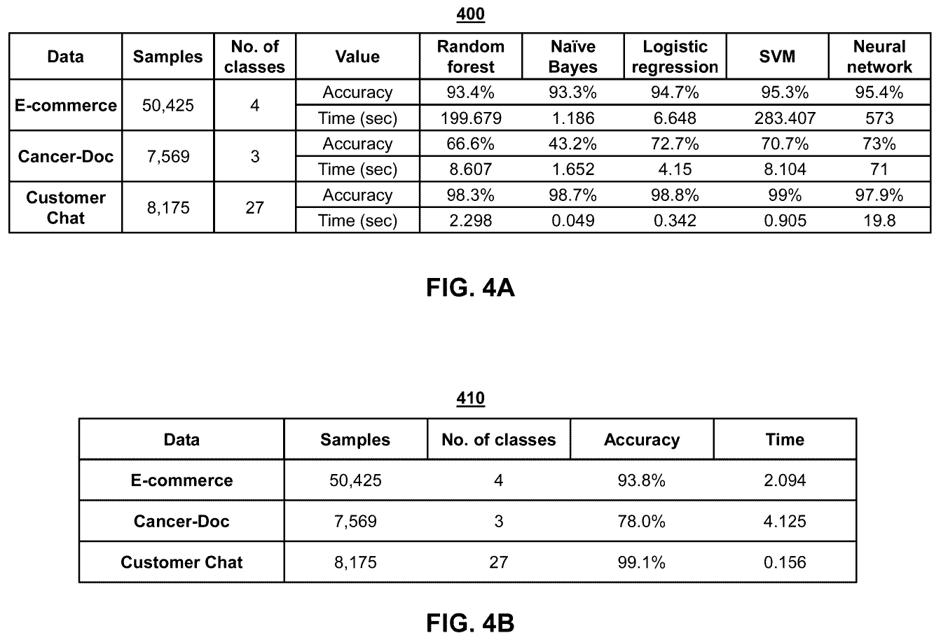

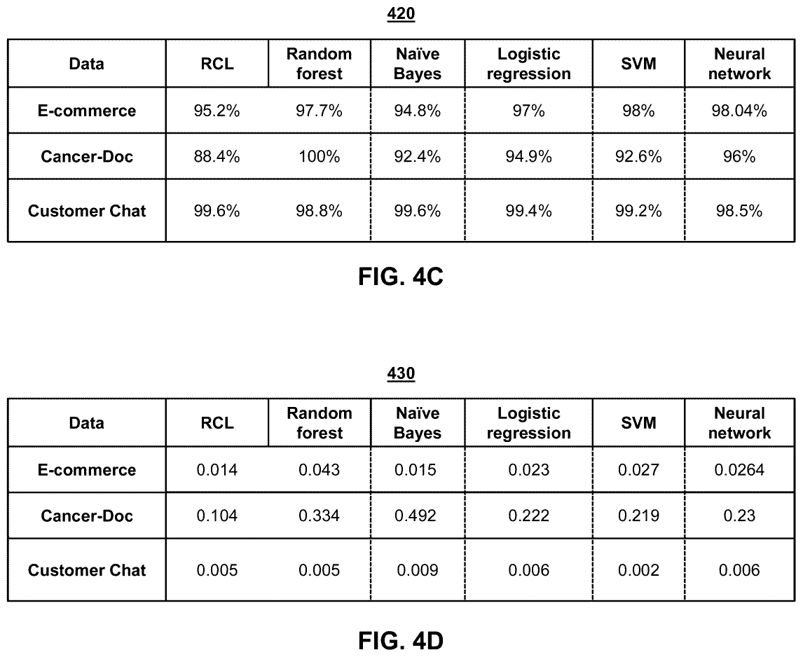

FIGS. 4A-4E are charts of example results for different domains with which an RCL-based model can be trained, in accordance with one or more embodiments. As use case examples, performance evaluations may be computed for different datasets. For instance, some datasets used can include e-commerce datasets, medical datasets, chat datasets, and/or other datasets. In some embodiments, the e-commerce datasets may include e-commerce text classification samples segmented into classes. For example, as illustrated in charts 400-440 of FIGS. 4A-4E, the e-commerce text classification datasets may include 50,425 samples grouped into 4 classes. In some embodiments, the medical datasets may include medical text datasets including cancer document classifications segmented into classes. For example, the cancer documentation classification datasets may include 7,569 samples grouped into 3 classes. In some embodiments, the chat datasets may include customer service chat datasets segmented into classes. For example, the customer service chat dataset may include 8,175 samples grouped into 27 classes.

FIG. 4A illustrates accuracy values and training times for different methods of machine learning and deep learning employed without duplicates using non-RCL techniques. Non-RCL experiments indicate that traditional ML models and neural network models have similar levels of accuracy, as indicated by chart 400. The main difference involves training time.

FIG. 4B illustrates accuracy values and training times for the given numbers of classes and samples without duplicates using RCL techniques. For instance, as shown by chart 410, for text classification tasks, RCL-based models (e.g., RCL model 110) show balance training time and accuracy across a variety of domains (e.g., e-commerce, cancer document classification, chats).

FIG. 4C illustrates a chart 420 of accuracy values for RCL-based models and non-RCL models with duplicated data.

FIG. 4D illustrates a chart 430 of differences between accuracy values with and without duplicates in the data. Chart 430 highlights the differences between the values obtained in chart 420 with the values obtained in charts 400 and 410.

FIG. 4E illustrates a chart 440 of accuracy and time values for RCL-based models and non-RCL models after duplicates have been removed.

FIGS. 5-7 are plots of example results comparing different model frameworks to RCL-based frameworks, in accordance with one or more embodiments. For example, as seen in plots 500-700 of FIGS. 5-7, when compared to other models, such as, for example, Random Forest models, Support Vector Machines (SVMs), Naïve Bayes models, Logistic Regression models, deep learning models, or other types of models, RCL-based models demonstrate superior performance in terms of training speed and accuracy. Furthermore, the RCL-based models showed improved performance and were effective in handling data duplication and leakage, maintaining high accuracy even with minimal data.

### Example Results

As an illustrative example of RCL-based model performance results, the following example is described. For instance, in the example, the dataset used included the EU Document English subset from OpenAI's GPT-J training dataset (The Pile). The hardware used to execute the tests included computing devices 2×32 Cores 2.3 GHz and 128 GB RAM, without GPU. The example RCL model demonstrated linear scaling behavior in various scenarios, including increasing dataset size with constant and dynamic entropy, and parallelizing processes across multiple virtual machines. When compared with neural networks, the RCL-based model outperformed the neural networks in training speed, inference speed, and model size. Neural networks showed exponential increases in training and inference times with the addition of neurons per layer, whereas RCL maintained linear scaling.

In some examples, a sequence length may be selected based on the task to be performed by a model (upon successfully being trained). For example, in the case of next word prediction tasks, the sequence length may represent the number of tokens to include in the sequence to predict a next word. For example, a sequence length of five (5) may indicate that a fifth token will be predicted based on a previous four tokens. To form the sequences, the tokens representing the reference text (e.g., Romeo and Juliet) may be analyzed using a sliding window function of a predefined size representing the context window. For example, for a sequence length of five tokens, the sliding window function may be five tokens long, with a step size of one. Applying this sliding window function to the reference text may create sequences of tokens, each having the same sequence length. Each sequence includes an initial token, three next tokens, and a final token. Upon creation of one sequence, the sliding window may be moved one token over to create a new sequence, this time including a new initial token (previously the first of the three “next” tokens), a new three next tokens (the next two of the three “next” tokens and the previous “final” token), and a new final token (the next token after the final token in the previous sequence).

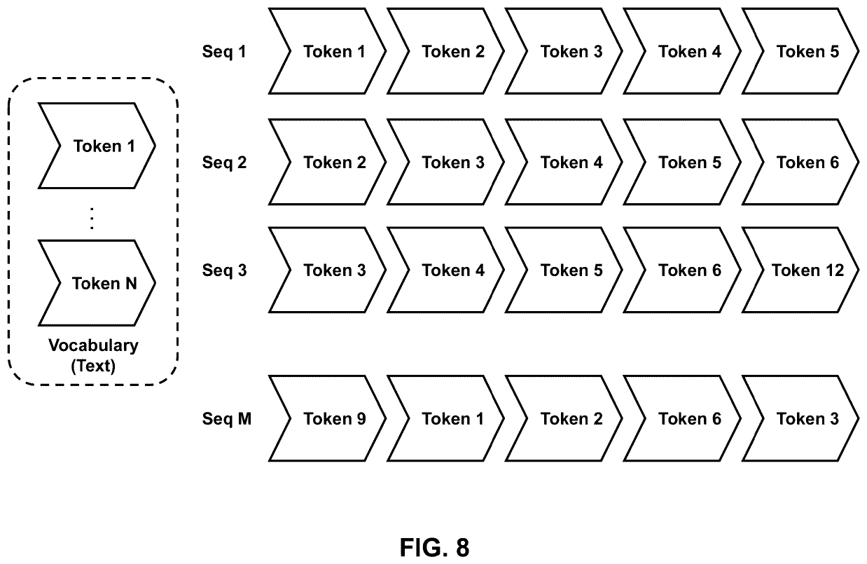

In the illustrative implementation of FIG. 8, computing system 102 may create sequences Seq1 thru SeqM, each including a same number of tokens. For example, “Seq1={“Token 1”, “Token 2”, “Token 3”, “Token 4”, “Token 5”}”; “Seq2={” Token 2”, “Token 3”, “Token 4”, “Token 5”, “Token 6”}”; “Seq3={“Token 3”, “Token 4”, “Token 5”, “Token 6”, “Token 7”}”; and so on.

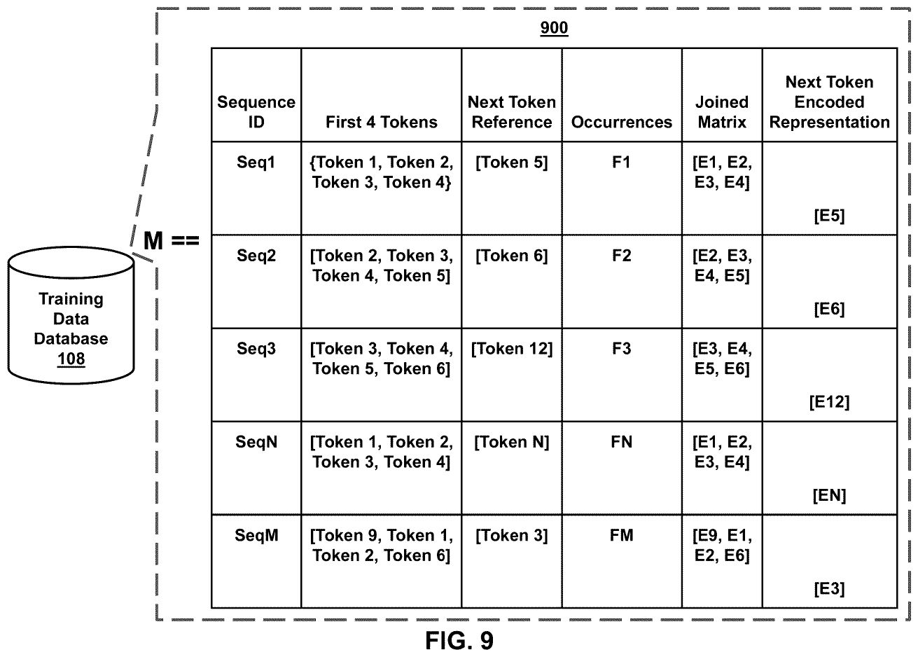

In some implementations, as seen in FIG. 9, the sequences (e.g., Seq1 thru SeqM) may be stored in training data database 108 for training a prediction model, such as RCL model 110 and/or ML model 112. In some implementations, computing system 102 may form training data 900 from the sequences of tokens extracted from the reference text. For each sequence, a sequence identifier, first four tokens, and fifth token in that sequence may be stored. Additionally, a weighting associated with that token (e.g., from a TF-IDF analysis of the importance of the token's corresponding word) may be stored for each sequence by training data 900.

In the example of FIG. 9, training data 900 may be structured as a tabular data structure, such computing system 102 can perform SQL-based searching. Alternatively, training data 900 may be stored using object-oriented data structures. For simplicity, training data 900 is illustrated as tabular data. For example, each sequence may be stored as a row in training data 900: a row for “Seq1” including the first four tokens (e.g., {“Token 1”, “Token 2”, “Token 3”, “Token 4”}), and the “next” token (e.g., “Token 5”), a row for “Seq2” including the first four tokens (e.g., {“Token 2”, “Token 3”, “Token 4”, “Token 5”}), and the “next” token (e.g., “Token 6”), and so on. When used for training (e.g., training RCL model 110), computing system 102 may provide, as input, the first four tokens of a given sequence. The prediction model (e.g., RCL model 110) may be trained to output a prediction of the next token. Computing system 102 can compare the predicted next token to the reference token (e.g., the known next token, “Token 5”) to determine how accurate the model was at predicting the next word for that sequence of tokens. In some examples, computing system 102 can update model parameters to improve prediction accuracy based on the comparison of the predicted token and the reference token. Alternatively, computing system 102 can update the model parameters after a certain quantity of sample sequences are provided as input to the prediction model.

In some implementations, the next word may be identified based on a frequency with which that word follows the previous four words. In other words, given the entire text (e.g., the entirety of Romeo and Juliet), the number of times that the sequence of tokens “Token 1”, “Token 2”, “Token 3”, “Token 4” occurred, in order, sequentially followed by “Token 5”, corresponds to the frequency or number of occurrences of that particular sequence. In the illustrated example, “Seq1” may be determined to occur F1 times within the entirety of Romeo and Juliet. For example, there are F1 occurrences of the sequence of text “Two households, both” being followed by the word “alike” in the entire text. The other sequences may have the same or different frequencies with which they occur within the text.

In some examples, the same four tokens may include a different fifth token occurring at different frequencies. For example, as seen in FIG. 9, both “Seq1” and “SeqN” include, as the first four tokens, “Token 1”, “Token 2”, “Token 3”, “Token 4”. However, “Seq1” may include, as the next token, “Token 5”, which occurs F1 times within the entirety of the text. On the other hand, “SeqN” may include, as the next token, “Token N”, which occurs FN times within the entirety of the text. For new sequences received including these same four tokens in that order (e.g., {“Token 1”, “Token 2”, “Token 3”, “Token 4”}, the prediction model may be trained to determine whether the next token is “Token 5” or “Token N”. As described herein, the selection of the next token by the prediction model may depend on the frequency with which each particular sequence occurs (e.g., whether F1 is greater than FN).

In some implementations, computing system 102 can facilitate transforming each token into an encoded representation. The encoded representation (e.g., an embedding) can represent the token in a format capable of being input to the prediction model (e.g., RCL model 110 and/or ML model 112). An encoded representation (e.g., an embedding) of a sequence refers to a numerical vector that captures the semantic meaning and contextual relationships of the sequence in a continuous space. Instead of representing words or tokens as discrete symbols, embeddings can map them to dense, lower-dimensional vectors where similar meanings have closer representations. This allows prediction models to process text efficiently, recognize patterns, and understand relationships between words beyond simple keyword matching.

In some examples, computing system 102 may generate the encoded representations without machine learning models or neural networks. For example, some example encoding techniques, such as one-hot encoding, bag-of-words (BoW), TF-IDF, n-gram encoding, count-based co-occurrence matrices, latent semantic analysis (LSA), principal component analysis (PCA), Huffman encoding, and others, may not rely on ML models or neural networks for encoding. With one-hot encoding, each word can be represented as a binary vector with a single “1” in a vocabulary-sized space, making it simple but sparse. With BoW, counts of word occurrences within a document without considering order, may be used to provide a basic frequency-based representation. With TF-IDF, BoW can be enhanced by weighting words based on their importance across multiple documents, improving relevance detection. These methods rely on statistical and rule-based techniques rather than learned embeddings from machine learning models. With n-Gram encoding, text can be represented by overlapping sequences of n words or characters, capturing local context efficiently. With count-based co-occurrence matrices, relationships between words can be represented based on their frequency within a context window, forming word-word or word-document matrices. With LSA and PCA, the dimensionality of BoW or TF-IDF representations can be reduced to capture hidden patterns in word usage. Additionally, Huffman coding can compress text using a frequency-based prefix coding scheme, commonly applied in text compression and parsing.

In some implementations, computing system 102 can apply one or more dimensionality reduction techniques (e.g., using LSA, PCA) to the input samples to reduce a model complexity. For example, by transforming high-dimensional input data (e.g., datasets including features extracted from text, numerical, or image data) into a lower-dimensional space that captures the salient information. The reduced dimensionality can reduce model complexity by using fewer inputs, simplify the data processing. Moreover, the dimensionality reduction can reduce noise, minimizing model overfitting.

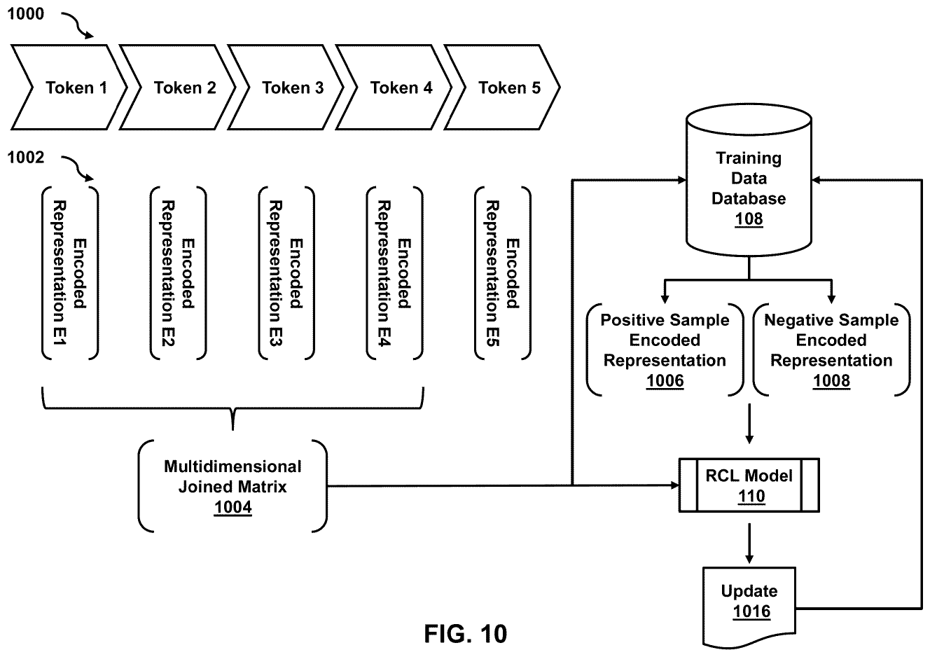

In some implementations, computing system 102 can train a prediction model, such as RCL model 110 and/or ML model 112, using the encoded representations of the tokens. For example, as seen in FIG. 10, sample sequence 1000 may include tokens: “Token 1”, “Token 2”, “Token 3”, “Token 4”, and “Token 5”. In sample sequence 1000, the first four tokens, “Token 1”, “Token 2”, “Token 3”, “Token 4” may represent a portion of sample sequence 1000 used as input for a prediction model (e.g., a training input). The last token, “Token 5”, may represent a portion of sample sequence 1000 used for ground truth/reference feedback (e.g., reference feedback). Computing system 102 may be configured to train a prediction model (e.g., RCL model 110) using encoded representations 1002, which correspond to sample sequence 1000.

Encoded representations 1002 may include encoded representations for each token from sample sequence 1000. For example, encoded representations 1002 may include encoded representation E1 corresponding to “Token 1”, encoded representation E2 corresponding to “Token 2”, encoded representation E3 corresponding to “Token 3”, encoded representation E4 corresponding to “Token 4”, and encoded representation E5 corresponding to “Token 5”. In some implementations, each of encoded representations E1-E5 may have the same dimensionality, however this is not required. The dimensions of each encoding method vary based on the vocabulary size, document count, and the specific technique used. For example, one-hot encoding can produce a vector with a dimension equal to the vocabulary size (i.e., if a corpus has 10,000 words, each word can be represented as a (10,000, 1) binary vector); BoW can also create a vector of the same size, but instead of binary values, it records the frequency of each word in a document; TF-IDF follows the same structure as BoW but assigns each word a weighted importance score instead of a raw count; for n-Gram encoding, dimensionality increases based on the chosen n value, with a vocabulary that grows exponentially with larger n; for count-based co-occurrence matrices, the dimensionality may have a (vocabulary size, vocabulary size) structure when tracking word-word relationships or (vocabulary size, document count) when tracking word-document relationships; for LSA and PCA, the dimensions of BoW or TF-IDF representations can be reduced, often down to a predefined number of principal components, such as (vocabulary size, reduced dimension); and with Huffman coding, used in text compression, the encoded representations may not have a fixed-dimensional representation but instead can encode words with variable-length binary sequences based on frequency. These encoding methods result in different levels of sparsity and computational complexity, influencing their suitability for various natural language processing tasks.

In the example of FIG. 10, each of encoded representations E1-E5 may be represented using a vector of length m, n, p, q, and z, respectively, which may be equal or different. For simplicity, encoded representations E1-E5 are considered to be of the same length.

In some implementations, computing system 102 may be configured to execute a multi-column join operation to join encoded representations E1-E4. For example, multidimensional joined matrix 1004 may represent encoded representations E1-E4. As described herein, multi-dimensional join operation causes multiple encoded representations (e.g., encoded representations E1-E4) to be joined along multiple dimensions to create a unified representation that preserves or enhances the relationships between them. Some example use cases where a multidimensional join operation can be used include natural language processing (NLP) and machine learning to merge embeddings from different sources, such as word embeddings, positional encodings, and/or contextual representations.

Multidimensional join operations can be performed in a variety of ways, such as row-wise, column-wise, concatenation, element-wise, element-wise (averaging), and the like. Row-wise join operations create a matrix having rows corresponding to the input encoded representations. For example, if the input sequence includes four vectors, each n elements in dimension, then the resulting multidimensional joined matrix may be 4×n. Column-wise join operations may create a matrix having columns corresponding to the input encoded representations. For example, for the input sequence including four vectors, each n elements in dimension, the resulting multidimensional joined matrix may be n×3. A concatenation operation can generate a single vector by concatenating the encoded representations. Element-wise addition may include adding, positionally, each encoded representation's element. For example, if vector A includes elements {1, 0} and vector B includes elements {0, 1}, then the multidimensional joined matrix of vectors A and B would be {1+0, 0+1}={1, 1}. Element-wise addition including averaging may be similar to element-wise join operations, with the exception that a mean value of each corresponding element may be computed.

In some implementations, computing system 102 may be configured to train a prediction model, such as RCL model 110, using training data generated by creating a multidimensional joined matrix 1004 for each sequence created. For example, returning to FIG. 9, training data 900 may include, for each sequence, a corresponding joined matrix and next token encoding. Each sequence may store the corresponding joined matrix as a training input and may store the next token encoded representation as reference feedback. For example, the first sequence, “Seq1”, may include a joined matrix formed by the joining of encoded representations E1-E4, which can serve as an input for training a prediction model.

In some implementations, computing system 102 may be configured to perform a Random Contrast Learning (RCL) to train RCL model 110. The RCL process refers to a self-supervised learning technique that improves representation learning by contrasting randomly selected pairs of data points. The goal with RCL is to train a model to distinguish between similar and dissimilar examples without requiring explicit labels.

In the context of next-word prediction, RCL training of RCL model 110 may include randomly sampling encoded representations from training data database 108. In some implementations, the randomly selected sample encoded representations may include a positive sample encoded representation 1006 (e.g., having contextual similarity (positive pairs)) and a negative sample encoded representation 1008 (e.g., not contextually similar (negative pairs)). Sample encoded representations 1006 and 1008 may be compared, using RCL model 110, to the input sample (e.g., multidimensional joined matrix 1004) to determine which one is most similar. A similarity measure, such as cosine similarity or dot product, may be computed to determine similarity. If two sequences are contextually similar, the model should learn to assign them a higher similarity score, while unrelated sequences should have a lower score.

In some implementations, RCL model 110 may be configured to have a contrastive loss function applied to optimize parameter tuning. A contrastive loss function can be used to generate an update 1016. Update 1016 can adjust the parameter tunings to indicate that positive pairs (i.e., sequences with similar meanings) have embeddings that are close together in an embedding space, while negative pairs (i.e., contextually unrelated sequences) have embeddings that are further apart. Computing system 102 may be configured to repeat this process iteratively, allowing RCL model 110 to refine the encoded representations stored in training data database 108 and learn meaningful distinctions between different sequences.

The contrastive learning process adjusts the encoded representations (e.g., positive sample encoded representation 1006 and negative sample encoded representation 1008) to reinforce these distinctions, improving RCL model 110's ability to predict a next word accurately. RCL enables models to learn contextual relationships between words without needing labeled datasets. This makes it effective for self-supervised learning in natural language processing (NLP) tasks, reducing the need for manually annotated data while enhancing generalization.

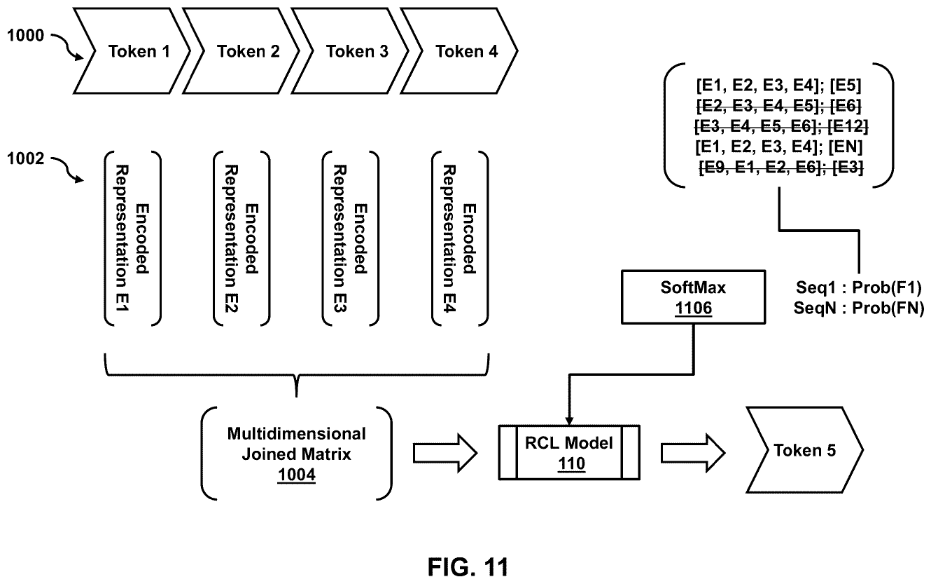

FIG. 11 is an illustrative diagram of an example process for determining the next token in a sequence using a trained RCL model, in accordance with various implementations. As an example, sequence 1100 may be selected as an input sequence with which a next token (e.g., corresponding to a next word) is to be predicted. In the illustrative example, sequence 1100 may include {“Token 1”, “Token 2”, “Token 3”, “Token 4”}. Upon receiving sequence 1100, computing system 102 may be configured to generate encoded representations 1102 including an encoded representation for each token. In some implementations, computing system 102 may be configured to generate a multidimensional joined matrix 1104 by performing a multidimensional join operation to encoded representations 1102. For example, multidimensional joined matrix 1104 may be generated using row-wise, column-wise, concatenation, element-wise, element-wise (averaging), or other join operation.

In some implementations, multidimensional joined matrix 1104 may be input to RCL model 110, which may determine candidate next tokens. For example, using multidimensional joined matrix 1104 as input, RCL model 110 may reduce the pool of candidate next tokens by filtering out any sequence that does not include the four tokens used to form multidimensional joined matrix 1104. For example, “Seq2”, “Seq3”, and “SeqM” do not form multidimensional joined matrix 1104 as they are comprised of different encoded representations than “Seq1” or “SeqN”, each of which include the same input sequence of tokens (e.g., {“Token 1”, “Token 2”, “Token 3”, “Token 4”}). Therefore, as compared to deep learning models where classification is performed across all possible output classes, the described process can reduce the number of computations down significantly to only those relevant to the task. For example, because “Seq2”, “Seq3”, and “SeqM” each are not possible solutions, they can be removed from consideration at run time, thereby simplifying the computations needed to be performed to determine the next token.

In some implementations, a probability of the input sequence (e.g., sequence 1100) corresponding to “Seq1” or “SeqN” may be determined. For example, the probability of the next token in the sequence being “Token 5” may be determined based on the frequency (e.g., occurrences) that “Seq1” is included in the training data and followed by “Token 5” as compared to “Token N”, as with “SeqN”. In some examples, an activation function may be used to convert the probabilities into a logical score for selecting the next token. For example, a SoftMax function 1106 may be applied to the probabilities to determine whether the next token should be “Token 5” or “Token N”. In some implementations, based on the activation function, an output 1108 can include the next token, which may be chosen by identifying the selected sequence's next token encoded representation, determine the next token, and map that token to its representative word. For example, in the example where frequency F1 is greater than frequency FN, “Seq1” may be selected. As “Seq1” includes encoded representation [E5] as its next token encoded representation, the corresponding token may be determined and mapped to its representative word (e.g., “alike”).

One advantage of the aforementioned process is the reduction in processing time achieved using the examples described herein. For example, because of the way in which the prediction model is trained (e.g., using random contrast learning), sequences that have not been encountered are not considered. In other words, because the example sequence includes tokens “Token 1”, “Token 2”, “Token 3”, “Token 4”, in that order, and only (in the example) “Seq1” and “SeqN” include a similar sequence, only the next token for “Seq1” and “SeqN” may be considered as possible options. This reduces the number of computations significantly as “Seq2”, “Seq3”, “SeqM”, and any other sequences that do not include those four tokens in that order, do not need to be included in the next word analysis. In contrast to traditional Transformer Neural Network, which include computations determining the likelihood of the next token being any of the N possible options, the described implementations reduce the computations to such levels that they can be performed using CPU-based systems.

In some implementations, an optimization process can be used to optimize the model parameter values. For example, for contrastive learning, some example optimization processes that can be used include, but are not limited to, Bootstrap Your Own Latent (BYOL), SimSiam, and Simple Contrastive Learning of Representations (SimCLR).

It should be noted that the example above relates to text classification, however the RCL process described herein can train models for other domains, such as image classifications. For example, instead of training one text sample, image samples can be used to train the model to predict classifications for those images. As an example, the images may be predicted to be in a first class or a second class, where the first class indicates that a particular object or set of objects was recognized within the image, while the second class may indicate that a particular object or set of objects was not recognized within the image. In some implementations, to train such a model, one or more feature extraction processes may be performed to encode the images for input. For example, Scale-Invariant Feature Transform (SIFT), Histogram of Oriented Gradients (HOG), Speeded-Up Robust Features (SURF), or other processes, can be used to generate the encoded representations of the images for created the training samples. For each pixel in the image, the model can learn a predicted “next” pixel (e.g., adjacent pixel). For example, based on an image gradient in the image, a next pixel can be predicted based on a directionality of other similar pixels in the image (or in other images).

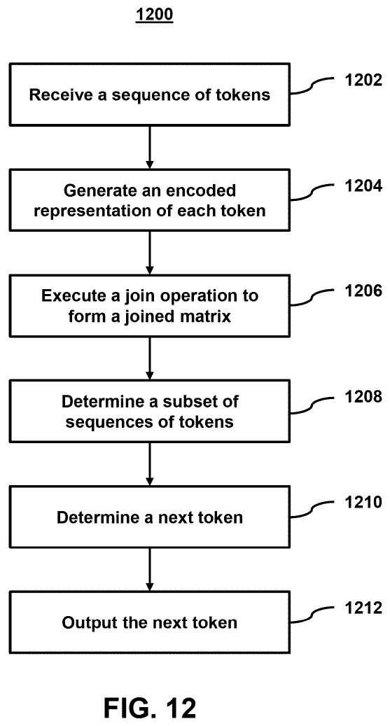

FIG. 12 is an illustrative flowchart of an example process 1200 for using a prediction model trained using random contrast learning, in accordance with various implementations. In some implementations, process 1200 may begin at step 1202. At step 1202, computing system 102 may be configured to receive a sequence of tokens. The sequence of tokens may include a predefined number of tokens determined in advance (i.e., based on context windows used during training). In some examples, the sequence of tokens may represent a sequence of words from a text. The sequence of tokens may be used to predict a next token, corresponding to a next word.

At step 1204, computing system 102 may be configured to generate an encoded representation of each token from the sequence of tokens. In some implementations, the encoded representation of each token may be generated using an encoding process, such as s one-hot encoding, bag-of-words (BoW), TF-IDF, n-gram encoding, count-based co-occurrence matrices, latent semantic analysis (LSA), principal component analysis (PCA), Huffman encoding, and others.

At step 1206, computing system 102 may be configured to execute a join operation to join the encoded representation of each token from the sequence of tokens to form a joined matrix. For example, joining operations including row-wise, column-wise, concatenation, element-wise, element-wise (averaging), joins, may be used.

At step 1208, computing system 102 may be configured to determine, using a prediction model, trained using random contrast learning, a subset of sequences of tokens comprising the sequence of tokens, wherein the subset of sequences of tokens are selected from a plurality of sequences of tokens used to train the prediction model.

At step 1210, computing system 102 may be configured to determine, using the prediction model, based on the subset of sequences of tokens, a token having a next token probability greater than or equal to a threshold probability.

At step 1212, computing system 102 may be configured to output, from the prediction model, the token based on the next token probability for the token being greater than or equal to the threshold probability.

### Example Results

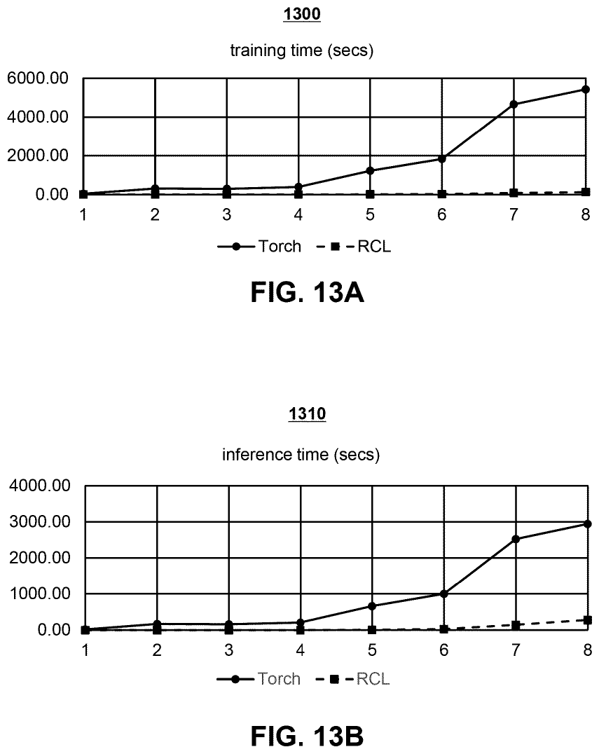

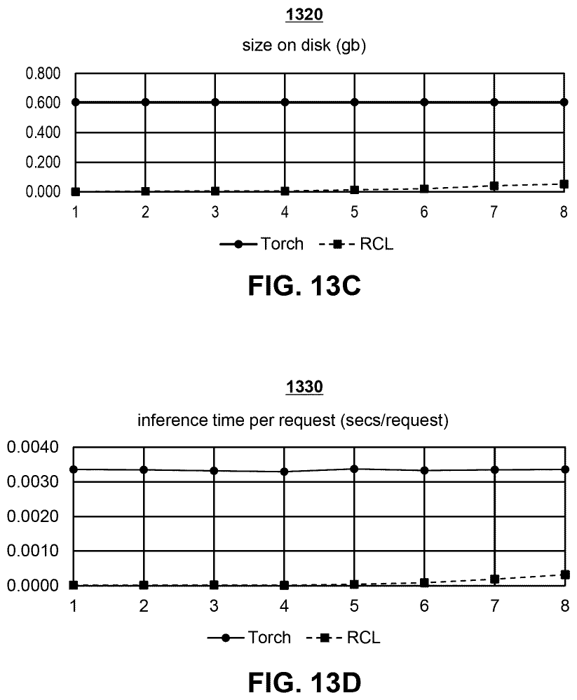

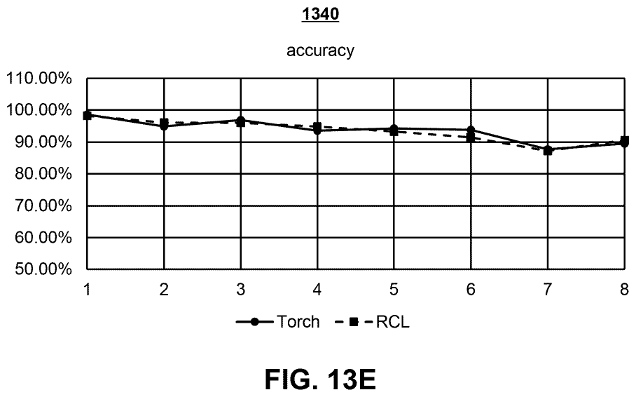

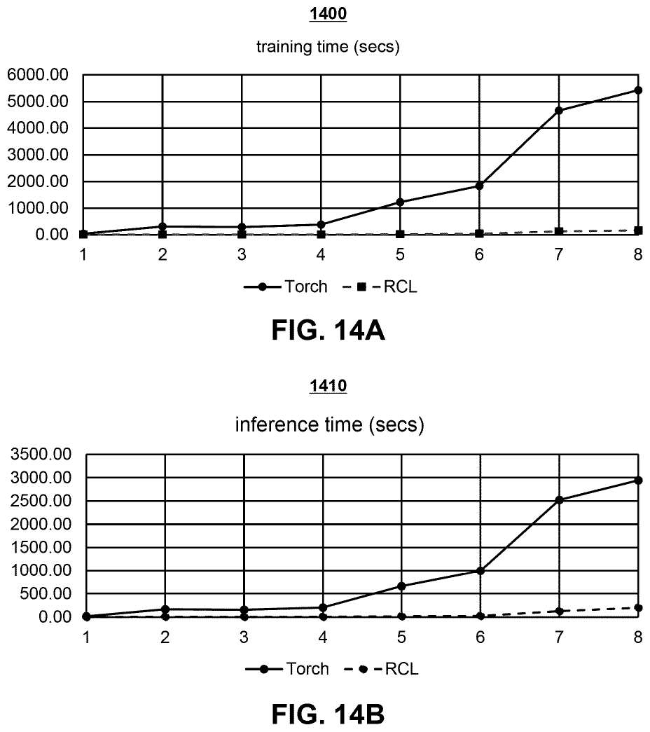

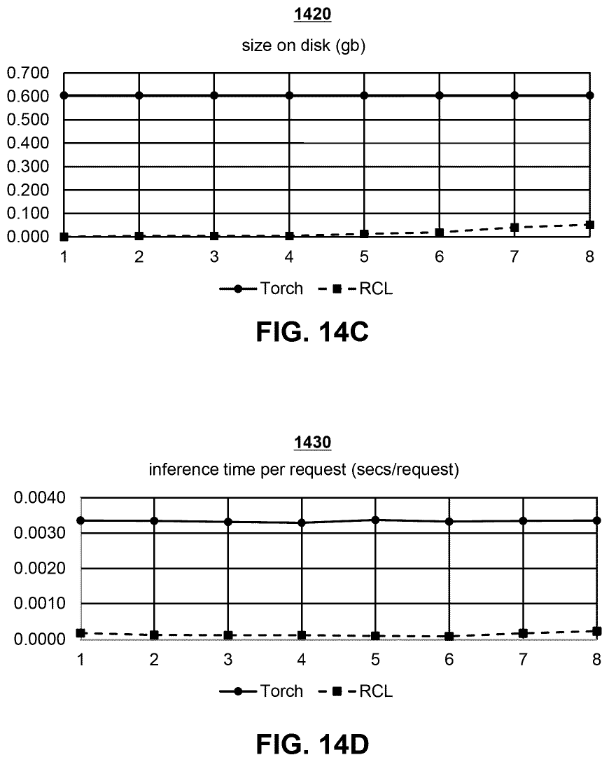

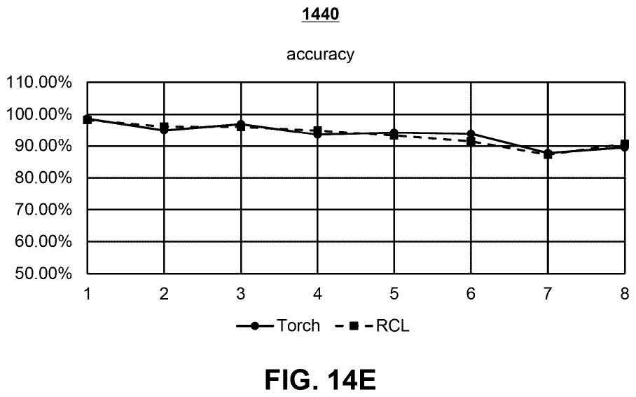

FIGS. 13A-13E and FIGS. 14A-14E illustrates various performance charts comparing a prediction model trained using RCL-based techniques (e.g., RCL model 110) and using non-RCL-based techniques (e.g., ML model 112), in accordance with one or more implementations. As an example, a PyTorch TNN may be used as ML model 112. Charts 1300 and 1400 of FIGS. 13A and 14A, respectively, plot training time for training an RCL model (e.g., RCL model 110) and a non-RCL model (e.g., ML model 112). Charts 1310 and 1410 of FIGS. 13B and 14B, respectively, plot inference time for predicting a result (e.g., a next word) for an RCL model (e.g., RCL model 110) and a non-RCL model (e.g., ML model 112). Charts 1320 and 1420 of FIGS. 13C and 14C, respectively, memory usage for an RCL model (e.g., RCL model 110) and a non-RCL model (e.g., ML model 112). Charts 1330 and 1430 of FIGS. 13D and 14D, respectively, a per request inference time for an RCL model (e.g., RCL model 110) and a non-RCL model (e.g., ML model 112). Charts 1340 and 1440 of FIGS. 13E and 14E, respectively, indicate an accuracy of the trained model for an RCL model (e.g., RCL model 110) and a non-RCL model (e.g., ML model 112).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein can be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor can be a microprocessor, or, any conventional processor, controller, microcontroller, soc (system on chip), som (system on module) or state machine. A processor also can be implemented as a combination of computing devices, such as a combination of a DSP and a microprocessor, a plurality of microprocessors, one or more microprocessors in conjunction with a DSP core, or any other such configuration. In some implementations, particular processes and methods can be performed by circuitry that is specific to a given function. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. The memory can be or include volatile memory or non-volatile memory, and can include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and programming products on any machine-readable media for accomplishing various operations. The implementations of the present disclosure can be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein can be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and that such variations are intended to be encompassed by the present disclosure.

What is claimed is:

1. A method, implemented using one or more processors, comprising:
initializing a random contrast learning (RCL) framework on input text datasets;
applying, based on the RCL framework, contrastive sampling to define learning objectives;
training a model using parameters determined from the contrastive sampling to obtain a trained model;
receiving, via the trained model, an input sample; and
generating, using the trained model, a prediction based on the input sample.

2. The method of claim 1, wherein the contrastive sampling comprises randomly selecting input samples to optimize classification tasks.

3. The method of claim 2, wherein the input samples comprise text samples, image samples, or video samples.

4. The method of claim 2, wherein the input samples comprise data sequences.

5. The method of claim 4, wherein the data sequences comprise text sequences.

6. The method of claim 1, wherein training the model comprises:
applying one or more dimensionality reduction techniques to the input samples to reduce a model complexity.

7. The method of claim 1, wherein the input sample comprises a text sequence, generating the prediction comprises determining a next token in the text sequence.

8. The method of claim 7, wherein the text sequence comprises a sequence of a predefined length, training samples included by the input text datasets have a length that is a same or similar length as the text sequence.

9. The method of claim 7, wherein the text sequence comprises an n-token sequence and the prediction comprises an n+1 token in the text sequence.

10. The method of claim 1, wherein the model comprises a classifier or a single node model.

11. The method of claim 1, wherein the one or more processors comprise one or more central processing units (CPUs).

12. The method of claim 1, wherein graphics processing units (GPUs), neural network models, and transformer models are not used to train the model.

13. The method of claim 1, wherein generating the prediction comprises:
receiving a sequence of tokens;
generating an encoded representation of each token in the sequence of tokens;
determining, using the model, a subset of sequences of tokens that comprise the sequence of tokens, the subset of sequences of tokens being selected from a plurality of sequences of tokens included in the input text datasets initialized using the RCL framework; and
executing a join operation to join the encoded representation of each token of the sequence of tokens to form a joined matrix.

14. The method of claim 1, wherein generating the prediction comprises:
receiving a sequence of tokens;
generating, using the model, a predicted next token in the sequence of tokens; and
providing, as a response to receipt of the sequence of tokens, the predicted next token.

15. The method of claim 1, wherein training the model comprises:
for a sequence of tokens of a plurality of sequences of tokens of the input text datasets:
generating a joined matrix comprising an encoded representation of each token of the sequence of tokens;
retrieving, from the plurality of sequences of tokens, a positive encoded representation comprising a positive sequence of tokens and a negative encoded representation comprising a negative sequence of tokens;
inputting the positive encoded representation, the negative encoded representation, and the joined matrix into the model to obtain a positive similarity score and a negative similarity score;
determining, based on the positive similarity score and the negative similarity score, a next token encoded representation; and
updating the joined matrix to increase the positive similarity score and decrease the negative similarity score, wherein an activation function is selected to determine, based on the positive similarity score and the negative similarity score, the next token encoded representation.

16. The method of claim 1, wherein generating the prediction comprises:
identifying, using a data pipeline, multiple data types within the input sample; and
transforming, using the data pipeline, the input sample from the multiple data types to including a single data type.

17. The method of claim 1, wherein generating the prediction comprises:
receiving telemetry data relating to predictions made by the trained model for a first data type; and
adjusting a feature of the input sample to be extracted for generating the prediction based on the telemetry data.

18. The method of claim 1, wherein training the model comprises:
tuning hyperparameters of the model using fractional sampling and greedy survivor halving to optimize model performance.

19. A system, comprising:
memory storing computer program instructions; and
one or more processors configured using the computer program instructions to:
initialize a random contrast learning (RCL) framework on input text datasets;
apply, based on the RCL framework, contrastive sampling to define learning objectives;
train a model using parameters determined from the contrastive sampling to obtain a trained model; and
responsive to receiving, via the trained model, an input sample, generating, using the trained model, a prediction based on the input sample.

20. One or more non-transitory computer-readable media storing computer program instructions that, when executed by one or more processors, effectuate operations comprising:
initializing a random contrast learning (RCL) framework on input text datasets;
applying, based on the RCL framework, contrastive sampling to define learning objectives;
training a model using parameters determined from the contrastive sampling to obtain a trained model;
receiving, via the trained model, an input sample; and
generating, using the trained model, a prediction based on the input sample.
